(19) United States
(12) Patent Application Publication
(10) Pub. No.: US 2022/0126710 A1
(43) Pub. Date: Apr. 28, 2022

(54) METHOD AND APPARATUS FOR THE SELECTIVE GUIDANCE OF VEHICLES TO A WIRELESS CHARGER

(71) Applicant: Momentum Dynamics Corporation, Malvern, PA (US)

(72) Inventors: Matthew L. WARD, Exton, PA (US); Francis J. McMAHON, Malvern, PA (US)

(21) Appl. No.: 17/646,844

(22) Filed: Jan. 3, 2022

Related U.S. Application Data
(63) Continuation-in-part of application No. 16/723,750, filed on Dec. 20, 2019, now Pat. No. 11,241,970.
Application No. 16/723,750 is a continuation-in-part of application No. 16/030,036, filed on Jul. 9, 2018, now Pat. No. 10,814,729.
Application No. 16/030,036 is a continuation-in-part of application No. 14/541,563, filed on Nov. 14, 2014, now Pat. No. 10,040,360.
(60) Provisional application No. 61/904,175, filed on Nov. 14, 2013.

(51) Int. Cl. B60L 53/126; B60L 53/62; B60L 53/66

(52) U.S. Cl. CPC B60L 53/126; B60L 53/66; B60L 53/62

(57) ABSTRACT

A system and method of charging an electric vehicle uses a modular ground transceiver station (GTS) having at least two ground transceiver assemblies (GTAs). Each GTA is adapted to align with a vehicle transceiver assembly (VTA) of the electric vehicle, and a guideline extends from at least one of the GTAs a predetermined distance for guiding the electric vehicle to the GTAs. The GTS is selected based on an active GTA configuration of the GTS and a VTA configuration of the electric vehicle. The electric vehicle is guided along the guideline for alignment of at least one VTA of the electric vehicle with at least one of the GTAs in response to at least one signal radiated by the guideline. Wireless charging is initiated upon verification of alignment of the at least one VTA of the electric vehicle and the at least one of the GTAs.

### CROSS-REFERENCE TO RELATED APPLICATIONS

This continuation-in-part application claims priority to U.S. patent application Ser. No. 16/723,750, filed Dec. 20, 2019, which, in turn, is a continuation-in-part of U.S. patent application Ser. No. 16/030,036, filed Jul. 9, 2018, now U.S. Pat. No. 10,814,729 issued on Oct. 7, 2020, which, in turn, is a continuation-in-part of U.S. patent application Ser. No. 14/541,563, filed Nov. 14, 2014, now U.S. Pat. No. 10,040,360 issued on Aug. 7, 2018, which, in turn, claims priority to U.S. Provisional Patent Application No. 61/904,175, filed Nov. 14, 2013, the disclosures of which are incorporated herein by reference in their entireties.

### TECHNICAL FIELD

The present disclosure relates generally to wireless power transfer, and more specifically to devices, systems, and methods related to wireless power transfer to remote systems such as vehicles including batteries. More particularly, the present disclosure relates to achieving alignment of primary induction charging coils and secondary induction coils on a vehicle in a wireless power transfer system.

### BACKGROUND

In recent years, with the adoption of high capacity, relatively lightweight batteries, interest in electric vehicles has been rekindled. Growth in the numbers of all-electric vehicles (also known as battery-electric vehicles (BEVs)) is predicted to soar with public investments in electrical infrastructure, bans of internal combustion engines (ICE), and pollution concerns.

With inductive coupling Wireless Power Transfer (WPT), misalignment of the secondary coil with the primary coil can cause loss of transfer efficiency. The present assignee's experience with professional bus drivers has shown that a ˜4 centimeters (<2 inches) alignment in the X/Y plane is achievable through use of visual indicators by experienced drivers using manual driving controls. WPT allows for automatic charging, without the need for charging station attendants or the for the driver, or a passenger, to dismount and plug in a charging cable.

Investment in autonomous driving has also accelerated technological innovation, with driver assistance software (e.g., parking assistance, automatic braking) already available in some electric vehicles. Fully autonomous vehicles (predominately BEVs) are anticipated to be in use before 2025 with autonomous package-delivery vehicles expected before wide availability of general passenger and freight transport.

### SUMMARY

Various examples are now described to introduce a selection of concepts in a simplified form that are further described below in the Detailed Description. The Summary is not intended to be used to limit the scope of the claimed subject matter.

A ground transceiver station (GTS) is provided having at least two ground transceiver assemblies (GTAs) adapted to charge an electric vehicle via one or more vehicle transceiver assemblies (VTAs) of the electric vehicle. The GTS includes a pair of side-by-side GTAs, where each GTA is adapted to align with a VTA of the electric vehicle. A first guideline extends in a first direction from at least one of the GTAs a predetermined distance, and a transmitter is adapted to transmit at least one signal over the first guideline for detection by the electric vehicle for use in guiding the electric vehicle along the first guideline for alignment of at least one VTA of the electric vehicle with at least one of the GTAs. The pair of side-by-side GTAs may be oriented in parallel to the first direction, wherein a first GTA is connected to the first guideline and the first guideline extends in the first direction. The GTS may further include an inductive communications system that enables the side-by-side GTAs to communicate with corresponding VTAs of the electric vehicle as the electric vehicle approaches the at least one GTA. The GTS may further include an enclosure for housing the pair of side-by-side GTAs, a separate enclosure for housing the transmitter, and a communications interface connecting the pair of side-by-side GTAs to the transmitter.

The GTS may further include a second guideline. In sample configurations, the pair of side-by-side GTAs are oriented perpendicular to the first direction, a first GTA is connected to the first guideline where the first guideline extends in the first direction, and a second GTA is connected to the second guideline in parallel to the first guideline. The transmitter may selectively transmit the at least one signal over at least one of the first guideline or the second guideline for detection by receiver antennas mounted on the electric vehicle and disposed on opposite sides of the first guideline and the second guideline as the electric vehicle approaches the at least one GTA. The first guideline may be adapted to radiate a first signal at a first frequency and the second guideline may be adapted to radiate a second signal at a second frequency for detection of at least one of the first signal or the second signal by the receiver antennas to guide the electric vehicle as the electric vehicle approaches the at least one GTA.

A second pair of side-by-side GTAs oriented perpendicular to the first direction may also be provided. In such a configuration, the at least one signal is detected by the receiver antennas to guide at least one VTA of the electric vehicle with respect to the first guideline or the second guideline to at least one GTA of the pair of side-by-side GTAs or the second pair of side-by-side GTAs.

In other configurations, a second pair of side-by-side GTAs oriented perpendicular to the first direction may be provided. In such a configuration, at least one of the first signal or the second signal is detected by the receiver antennas to guide at least one VTA of the electric vehicle with respect to the first guideline or the second guideline to at least one GTA of the pair of side-by-side GTAs or the second pair of side-by-side GTAs.

In sample configurations, the transmitter may transmit a GTS beacon from the at least one GTA of the pair of side-by-side GTAs or the second pair of side-by-side GTAs over the first guideline or the second guideline for detection by the receiver antennas to guide at least one VTA of the electric vehicle to the at least one GTA of the pair of side-by-side GTAs or the second pair of side-by-side GTAs depending on whether the first guideline or the second guideline is used to transmit the GTS beacon.

The first and second long-line guidelines may be in several different configurations. In a first configuration, the first guideline and the second guideline share a common trench. In a second configuration, the first guideline and the second guideline are discontinuous and are connected to a common antenna wire guideline by a switch. In a third configuration, the first guideline is a dipole guideline comprising first and second guideline spans and the second guideline is a dipole guideline comprising third and fourth guideline spans, where the first guideline and the second guideline extend 1/4 wavelength of a first guidance signal transmitted over at least one of the first guideline or the second guideline.

In other configurations, the GTS includes a third guideline that is longer than the first guideline and the second guideline and that radiates a second guidance signal that is discernable from the first guidance signal by a separation in frequency, time, or signal coding. The third guideline may comprise first and second long-line elements that are brought together in a zone at an end of the first guideline and the second guideline in the first direction, and extend from the zone in the first direction in a common trench. The first and second long-line elements may be discontinuous and connected to a common antenna wire guideline in the zone by a switch. Also, the third guideline may provide approach guidance to the electric vehicle over a first distance, and the first guideline and second guideline may provide approach guidance to the electric vehicle over a second distance shorter than the first distance. The third guideline may further radiate a first beacon signal and at least one of the first guideline or the second guideline may radiate a second beacon signal.

In yet other configurations, the GTS includes an end-of-line short range transmitter at an end of the third guideline. The end-of-line short range transmitter may receive data from at least one of the GTAs via the third guideline and broadcast a location of the at least one GTA and capabilities of the GTS. The end-of-line short range transmitter may broadcast information including at least one of power levels offered by the GTS or payment forms available. The end-of-line short range transmitter may further broadcast information including frequency, modulation, and coding of at least one of the first or second guidance signal for use in matching an active GTA configuration of the GTS with a VTA configuration of the electric vehicle. In sample configurations, the end-of-line short range transmitter is powered via the third guideline using a DC offset to at least one of a first beacon signal that radiates from the third guideline.

In still other configurations, the GTS includes third and fourth guidelines extending in a second direction opposite to the first direction from the second pair of side-by-side GTAs. At least one of the third or fourth guidelines may be adapted to radiate a guidance signal that is detected by the receiver antennas to guide the at least one VTA of the electric vehicle with respect to the third guideline or the fourth guideline to at least one GTA of the pair of side-by-side GTAs or the second pair of side-by-side GTAs.

In further configurations, the GTS further includes a second guideline extending away from at least one of the GTAs a predetermined distance in a second direction opposite to the first direction. In this configuration, the first guideline and the second guideline may be adapted to radiate respective guidance signals for guiding an electric vehicle to at least one of the GTAs from the first direction or the second direction.

Methods of charging an electric vehicle via at least one vehicle transceiver assembly (VTA) of the electric vehicle using a ground transceiver station (GTS) is also provided. In sample methods, the GTS includes a pair of side-by-side ground transceiver assemblies (GTAs) where each GTA is adapted to align with a VTA of the electric vehicle. A first guideline is also provided that extends in a first direction from at least one of the GTAs a predetermined distance. The methods include the steps of: selecting the GTS for charging the electric vehicle using information provided by the GTS based on an active GTA configuration of the GTS and a VTA configuration of the electric vehicle; guiding the electric vehicle along the first guideline for alignment of at least one VTA of the electric vehicle with at least one of the GTAs in response to at least one signal radiated by the first guideline for detection by the electric vehicle; aligning the at least one VTA of the electric vehicle and the at least one of the GTAs; and initiating wireless charging of the at least one VTA of the electric vehicle upon verification of alignment of the at least one VTA of the electric vehicle and the at least one of the GTAs. In sample methods, each aligned VTA operates independently of each other VTA, and each aligned GTA, paired with a VTA, operates independently from each other GTA.

The methods may include selecting the GTS for charging the electric vehicle by reserving the GTS, where the GTS has a GTA configuration that is compatible with a VTA configuration of the electric vehicle. The location or estimated arrival time may be updated to a reservation system as the electric vehicle approaches the selected GTS.

The methods may further include selecting the GTS for charging the electric vehicle by querying the at least one VTA for vehicle information including at least one of battery voltage and State of Charge (SoC) or desired SoC. Selecting the GTS for charging the electric vehicle nay further include optimizing at least one of matching a VTA configuration of the at least one VTA of the electric vehicle and a GTA configuration of the at least one of the GTAs, time-required-to-charge, next available compatible GTS, or next available GTS irrespective of a number of GTAs.

The methods also may prioritize a GTS for selection based on at least one of customer affinity of the electric vehicle, whether the electric vehicle has a reservation, whether the electric vehicle is part of a fleet, or availability of a GTS having a GTA configuration that is compatible with a VTA configuration of the electric vehicle. Also, an emergency vehicle may be prioritized over other electric vehicles for charging by a particular GTS.

The methods also may include detecting foreign or live objects prior to initiating wireless charging and during wireless charging. Also, continuous full-duplex inductive communication between each active GTA and each active VTA may be maintained during wireless charging for monitoring at least one of charging equipment status, detecting changes in position of the electric vehicle during charging, or changes to a state of the electric vehicle.

This summary section is provided to introduce aspects of the inventive subject matter in a simplified form, with further explanation of the inventive subject matter following in the text of the detailed description. The particular combination and order of elements listed in this summary section is not intended to provide limitation to the elements of the claimed subject matter. Rather, it will be understood that this section provides summarized examples of some of the configurations described in the Detailed Description below.

### BRIEF DESCRIPTION OF THE DRAWINGS

The foregoing and other beneficial features and advantages of the invention will become apparent from the following detailed description in connection with the attached figures, of which:

FIG. 1 illustrates a wireless electric vehicle charging station in a sample configuration.

FIG. 2A illustrates an exemplary structure and configuration for a Vehicle Transceiver Station (VTS).

FIG. 2B illustrates the wireless charging and communication signals with signal ranges between the Vehicle Transceiver Station (VTS) and Ground Transceiver Station (GTS).

FIGS. 2C, 2D, 2E, 2F, 2G, and 2H illustrate different exemplary configurations of Vehicle Transceiver Assemblies (VTAs) on electric vehicles of different sizes and models.

FIG. 3A illustrates a high-level view of the Ground Transceiver Station and its single wire antenna guideline.

FIG. 3B illustrates a high-level view of the Ground Transceiver Station and its center-fed, parallel wire antenna guideline.

FIG. 3C illustrates a high-level view of the Ground Transceiver Station with an end-fed, folded dipole antenna guideline.

FIG. 4A illustrates at a high-level a guidance configuration for a side-by-side (2×1) GTS charger.

FIG. 4B illustrates at a high-level a guidance configuration for a 1×2 in-line GTS charger.

FIG. 4C illustrates at a high-level a guidance configuration for a 2×2 square GTS charger.

FIG. 5A illustrates a long-line guideline in combined use with a dipole antenna guideline.

FIG. 5B illustrates a pinched two-wire long-lead guideline in combined use with a set of dipole antenna guidelines.

FIG. 5C illustrates a switched two-to-one long-lead guideline in combined us with a set of dipole antenna guidelines.

FIG. 6 illustrates a high-level view of an electric vehicle (EV) charging station including multiple GTSs.

FIG. 7 illustrates a long-line guideline with short-range beacon in combined use with a set of dipole antenna guidelines.

FIG. 8A illustrates a GTS with guidelines for guided approach and departure from opposing sides.

FIG. 8B illustrates a curbside GTS with guidelines for guided approach and departure from opposing sides.

FIG. 9 illustrates back-in parking for EVs using guidelines for approach.

FIG. 10 illustrates EV systems for guidance and wireless charging in a sample configuration.

FIG. 11 illustrates mandatory and optional sensor positions on vehicle for guidance and alignment positioning on approach to a GTS.

FIG. 12A topologically illustrates initial acquisition of the guideline signal.

FIG. 12B topologically illustrates a target approach with additional acquisitions of the guideline signal.

FIG. 12C topologically illustrates the end of approach with acquisition of the target signaling.

FIG. 13 illustrates an exemplary procedure for charging a WPT-equipped electric vehicle in a sample configuration.

### DETAILED DESCRIPTION

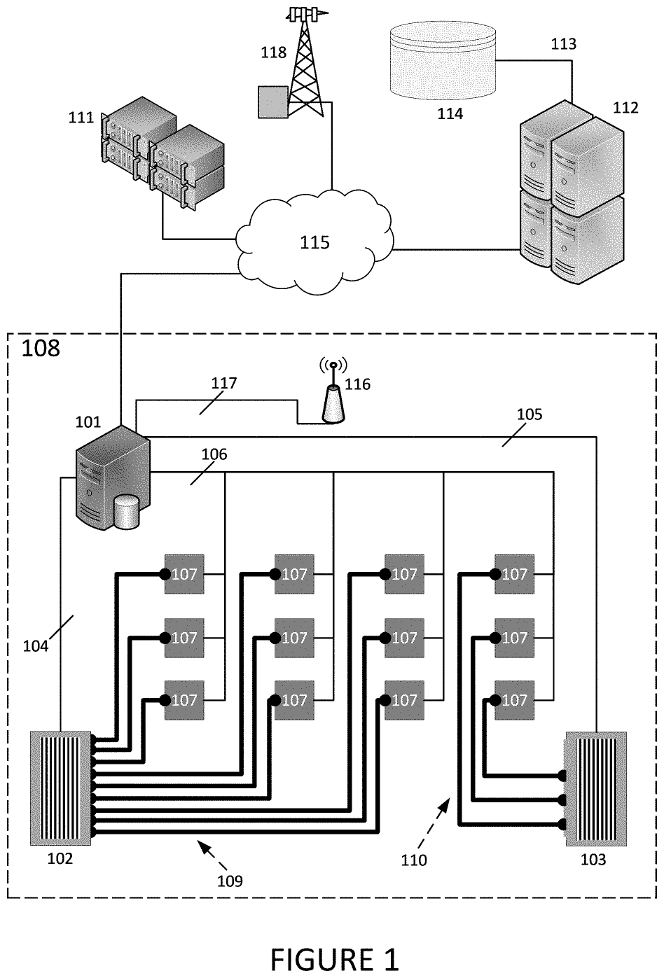

A detailed description of illustrative configurations will now be described with reference to FIGS. 1-13. Although this description provides a detailed description of possible implementations, it should be noted that these details are intended to be exemplary and in no way delimit the scope of the inventive subject matter.

Directions are provided herein in accordance with the common meaning. Using ISO 4130:1978, “Road vehicles—Three-dimensional reference system and fiducial marks” as a guide to the Cartesian coordinate system, forward is the −x direction, +x is the reverse or backwards direction, right is the +y direction and left is the −y direction. The horizontal z=0 plane corresponds to ground-level, grade, or pavement level with +z being the upwards direction and −z being the downwards direction (below grade).

The term “battery” is used herein to depict a generic chemical energy storage system and could be replaced, supplemented, or hybridized with other portable energy storage systems (e.g., solid-state batteries, reversable fuel cells, ultra-capacitors). Also, while many of the examples used are of a wireless power transfer (WPT) system used to power the onboard systems and charge the batteries of a stationary electric vehicle (EV), this use is by no means the only use contemplated.

The term electric vehicle (EV) includes all battery-operated electric vehicles (BEV) as well as hybrid EVs (HEV) and Dual charging (DBEV) with both plug-in and wireless charging capability.

As the electric vehicle (EV) fleet grows in number and the percentage of driver assisted and driverless (fully autonomous) increases, the need for automatic charging of rechargeable energy storage systems (e.g., chemical battery, solid-state battery, capacitive, reversible fuel cell) will similarly increase. The convenience, safety, reliability, and fully automated nature of wireless inductive charging are expected to only increase in value as the power needed for the seemingly insatiable need for reduction in charging session duration is met with higher power chargers.

The advantages of a modular approach to wireless power systems also comes into play. By manufacturing a standard Ground Transceiver Assembly (GTA) and a standard Vehicle Transceiver Assembly (VTA), economies of scale can be achieved as the GTAs are combined into larger Ground-Transceiver-Stations (GTSs) to serve the Vehicle-Transceiver-Stations (VTSs) consisting of VTAs configured and mounted on electric vehicles.

Public (general access) charging stations and non-public charging depots can be designed with configurable GTSs that adapt to the requirements of the VTS immediately prior to charging service and thus service the diverse set of the largest, smallest, nominal, or most numerous vehicle VTS configurations. Having a guidance system to direct the EV to the selected and appropriately configured GTS (one that fully utilizes the power transfer capability of the vehicle mounted VTS) is therefore important for optimal use of scarce electrical charging resources and vehicle operation time. Implementation of WPT Ground-Transceiver-Stations and Vehicle-Transceiver-Stations using a modular coil design has proven practical and economic, and sensitivity to coil misalignment is compounded as the Ground (GTS) and Vehicle (VTS) installations get larger. Coil misalignment can cause a drop in power transfer efficiency resulting in longer charging times and wasted energy.

### FIG. 1

FIG. 1 illustrates a control system for the operation of multiple Ground Transceiver Stations (GTSs) of a charging station or depot with contactless, automatic, wireless charging in example configurations. This illustrative design can function to charge Electric Vehicles (EVs) with differing configurations of Vehicle Transceiver Assemblies (VTAs) comprising the vehicle's Vehicle Transceiver Station (VTS).

The ability of the wireless charging station to charge differing configurations of VTSs enables the charging of private fleets of EVs (e.g., delivery trucks, delivery vans, and drayage vehicles) as well as varying electric and hybrid vehicle types, each type with a potentially different VTS configuration. The flexible, dynamically assignable, dynamically configurable GTS configurations (e.g., 1 Ground Transceiver Assembly (GTA) per GTS, 2 side-by-side (2×1) GTAs per GTS, 2 in-line (1×2) GTAs per GTS, 3 in-line (1×3) GTAs per GTS, 4 GTAs (2×2) per GTS, 6 GTAs (2×3) per GTS, or any GTA configuration and in numbers that supports the largest vehicle VTA configuration planned for the charging station) and public GTSs described herein may serve a multitude of EVs with different VTA configurations which need to be matched to a GTS with the corresponding configuration of GTAs or a superset GTA grid (where the selected GTS can selectively enable its GTA array to service the EV's VTS configuration).

Note that the example GTSs use the common configurations to match to the VTAs mounted on the underside of the EV. Other VTS configurations and VTA positioning on the vehicle may be supported for specialty EVs, for instance drayage vehicles or water-borne ferries that move from one fixed position to another may have a side-mounted VTS to take advantage of a vertical GTS mounting position on a loading dock while railway vehicles might have long, narrow GTS deployments due to the constraints of rail spacing and railcar VTS mounting.

The exemplary charging station design detailed in FIG. 1 is also well suited to serve driver piloted EVs, EVs with driver assistance software, and fully autonomous EVs. In FIG. 1, the charging station 108 is designed to support varied levels of integration between the EV and Wireless Power Transfer (WPT) systems, ranging from bolt-on (after-market) retrofits to complete OEM integrations with the EV and its Battery Management System (BMS).

The charging station controller 101 in FIG. 1 contains the software to manage the electrical supplies 102 and 103, the internal communication links 104, 105, and 106, the wireless GTSs 107, and secure data interconnection network 115 to entities (servers, data repositories) external to the charging station 108. The charging station controller 101 (a generic computer or computer cluster running station management software and database software) is also responsible for setting charging session parameters when the vehicle is being charged by way of a rules-based software engine.

The charging station controller 101 processes all data received via the secure, encrypted, short-range communications system 116 from the vehicles.

The charging station controller 101 is responsible for assigning GTSs 107, handles broadcast information and two-way controller to vehicle communications via the local short-range communications system 116, and selective activation of the station's in-pavement guidance antenna, and/or light-based signaling (not shown).

The charging station controller 101 also supports necessary encryption and security for data link establishment as well as secure storage of identifiers, authentication, and authorization to charge.

The charging station controller 101 may, in some configurations, further include a local database containing GTS configuration, status, and performance data as well as local copies of vehicle data for vehicles that have recently charged, vehicles with an upcoming charging reservation, and default vehicle data values for a set of EVs. The station controller 101 database can contain information from the reservation system 112 or proxy vehicle management systems (for instance those at a dispatch office or rental agency) (not shown). This information downloaded to the station controller 101 database would pertain to future scheduled arrivals and past charging events and EVs.

GTS data may include magnetic signal characteristics for each GTA (e.g., instantaneous power level during charging session, base signal frequency, frequency drift, signal phase offset, and nominal coil-to-coil gap) based on the aligned VTA and local conditions such as power availability, environmental factors (e.g., temperature) and installed GTA conditions (e.g., internal temperature(s), usage factors, number of coils per GTA, number of turns per GTA, surface mounted or flush mounted GTA(s), etc.).

The charging session parameters also may include the charger profile of each potential GTA pairing. Paired GTAs, and virtually paired GTAs are especially useful in reduction of magnetic emissions as detailed in Patent Application No. PCT/US21/70876; “EFFICIENCY GAINS THROUGH MAGNETIC FIELD MANAGEMENT”; Filed Jul. 14, 2021 when charging wirelessly.

The reservation system 112 is typically external to the charging station 108 and may serve one or more charging stations 108 over a service area (e.g., geographic, national, continental, worldwide). Vehicle data and authorization-to-bill data is stored in a database 114 accessible by the reservation system 112. In some cases (as shown), the database 114 may be remote from the reservation system 112 and require a secure digital datalink 113.

The vehicle data contained in the database 114 (and/or locally in the station controller 101 database may include details of the EV's magnetics charging profile for the VTS's vehicle coil assembly(s) and/or the GTS's ground coil assembly(s). Said vehicle data is accessible prior or during a charging session and may be amended with new historical measurements for each VTA during or after charging. The charging profile may include frequency response and charging models for setting charging parameters during the charging session. The charging profile stored in the database 114 may include a default profile for the EV or VTA type.

In example configurations of the wireless power transfer system, the EV charging profile may include the VTA frequency offset; make, model, and manufacturer of the VTA; a number of VTAs; positioning of VTAs; minimum and maximum current and voltage support of each VTA; health status of each VTA; temperature limitations of each VTAs; temperature readings of each VTA; and/or cooling availability for the VTS.

The station controller 101 also may obtain the number and placement of VTS of an electric vehicle to be charged from the charging profile for the EV to be charged; and then to select, for sending charging signals, a pattern of GTAs from the GTS's n-to-m grid of GTAs corresponding to the number and placement of the VTA for the vehicle to be charged.

The reservation system 112 may optionally house a geographic information system (GIS) and services exchange (e.g., a reservation system that allows access to current status and schedule for each charge station and charging lane with coordination of arrival time, charging planning, charging session scheduling, and tracking of loading/unloading rates or other services while maintaining privacy across fleet providers by database partitioning, anonymization and abstraction) enabling access to charger location, charger status and charging station services availability as well as supporting a charger reservation system. A digital data network 115 allows access to the reservation system 112 either from the charging station controller 101 or an optional intermediate data processing and storage system 111 which can serve as a regional or customer-specific data server and file repository.

Each GTS 107 of the charging station 108 is supplied power from the first power supply 102 or the second power supply 103 via power feeds 109 and 110. The first power supply 102 uses a digital datalink 104 to communicate status and alarms to the charging station controller 101. The second power supply 103 similarly uses a digital datalink 105 to communicate status and alarms to the charging station controller 101. The charging station controller 101 sends initiate, charge level, and terminate commands to the first 102 and second 103 power supplies using their respective datalinks 104 and 105 during a charging session.

Reservation or information sessions between the EV driving system (or EV driver using a wireless data device) are enabled thru Wide Area Wireless Access Networks (e.g., Cellular radio) shown here as base station 118 connected, via the landside packet network 115, to either a remote reservation system 112 or the local station controller 101. The charging station controller 101 may optionally support local Wireless Local Access Network access point(s) 116 (e.g., an IEEE 802.11 WI-FI® access point) connected via datalink 117 to the charging station controller 101.

Heavy use of WPT charging at the charging station 108 may lead to power grid fluctuations as the EVs start and complete charging sessions. These fluctuations can occur both at the start of a charging session and at the end of the charging session. These fluctuations from servicing the charging vehicles are not expected to be problematic for light use but is expected to worsen the larger the charging station and the heavier the usage becomes. The power demand fluctuation issue may happen at large depot-level charging stations as well as WPT-equipped loading docks and other large, concentrated WPT deployments.

In one configuration, a localized microgrid storage system (not shown) is installed to balance/level impact seen from a larger electrical supply grid. The microgrid storage solution can be chemical battery, solid-state battery, or capacitive based. By isolating the charging station 108 to a microgrid, the storage system serves to buffer the local demand from the larger electrical utility grid. An Energy Storage Systems (ESS not shown) can both supplement the power delivery to the local station microgrid, as well as bolster the wired electrical grid capacity.

In a second configuration, under control of the charging station controller 101, the GTSs 107 start-of-charging time (post alignment) and ramp-up rates can be adjusted to prevent overly large, undesirable power demand fluctuations.

In another configuration, use of the reservation system 112 may have coordinated, staggered charging session start times. A rough estimate for end-of-session time based on vehicle information received by the charging station controller 101 can be calculated using a default minimum recharge threshold for the vehicle. This can inform the reservation system 112 which can use session timing information to set reservation times.

With vehicle information received by the charging station controller 101 and pre-charging session State of Charge (SoC) a more precise estimated completion time can be calculated pre-charging. The minimum or desired SoC objective of the charging session also may be uploaded to the charging station controller 101.

The actual start-of-charge time, the pre-session vehicle SoC and the rough and more precise end-of-charge information can be sent to the reservation system 112 to allow better forecasting. The EVs may report number of VTAs installed, those currently inoperative, to allow the station controller 101 to assign a charger (e.g., GTS-equipped parking spot, stall, or position) where the operative VTAs can all be used in a charging session.

In another configuration, a parallel queue of GTSs may have an isolated power supply 103, limiting power fluctuations.

Alternative configurations (that may be also be used in combination) also include use of lane markings, illuminated lane signaling devices (e.g., traffic lights), or radio communications (between the charging station controller 101 and the EV-based driver, driver assistant, driver assistance software, or autonomous driving system) either over the inductive communications system (not shown), over short-range (e.g. WLAN) access point(s) 116 or using wide-area radio communications systems base station(s) 118 to coordinate movement of EVs to and between GTSs 107. The described configurations for power fluctuations control can be performed individually or with any or all configurations used in the GTS 107 deployment for power fluctuation control.

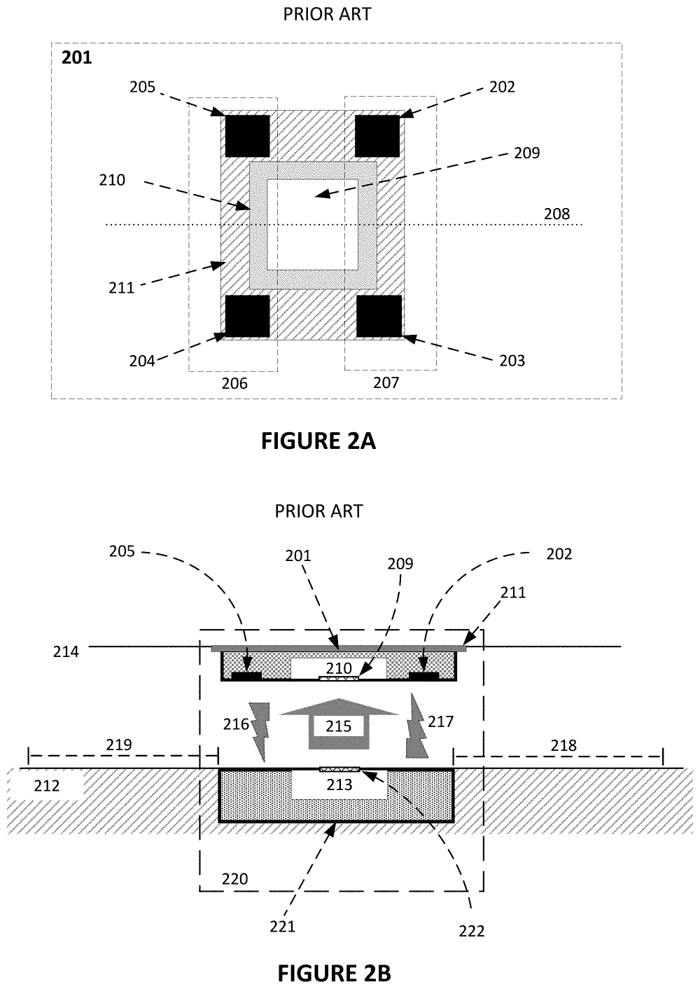

### FIG. 2A

FIG. 2A shows an exemplary structure and configuration for the Vehicle Transceiver Station (VTS) 201 with emphasis on the inductive communication and charging receiver and transmitter antennas. Not shown for brevity are the heating, cooling, and electrical connections.

In this illustrative example, a single Vehicle Transceiver Assembly (VTA) comprises the VTS 201.

In this example configuration, four planar inductive communication receiver loop antennas 202, 203, 204, and 205 are distributed around the periphery of the VTA 201 separated into a front pair 206 and a back pair 207, with each pair symmetric around the VTA centerline 208. This symmetry eases both the manufacture of the VTA 201 and the computational algorithms used for calculating guidance vectors and alignment. The receiver antennas 202, 203, 204, and 205 are dual use for data communication and as sensors.

In this configuration, a single planar loop antenna for communication transmission 209 is located centered in the VTA 201 and overlying the power (nominally receiver) coil 210. The power receiver coil 210 with its ferrite and eddy current shielding depends from the VTA mounting plate 211, which also supports the inductive receiver loop antennas 202, 203, 204, and 205. The VTA mounting plate 211 is structural but can also serve as an eddy current shield and a cold plate heat sink and radiator. One or more VTAs are nominally fastened by the EV underside via individual VTA mounting plate(s) 211 although a single larger mounting plate designed and physically sized to mount multiple VTAs could be used.

### FIG. 2B

FIG. 2B illustrates the wireless charging and communications signals with signal ranges used in automatic wireless charging at a GTA 221 that is aligned and paired with the vehicle-mounted VTA 201 to form a GTA/VTA pairing 220 in example configurations. In FIG. 2B, a single GTA 221 and a single VTA 201 are shown for the purposes of clarity, but it will be appreciated that the GTS may include multiple GTAs 221 and the VTS may include multiple VTAs 201.

For automatic charging, the GTA 221 shown here as embedded to be flush with the surface of the pavement 212. The GTA Power Coil 213 must be well-aligned with the VTA Power Coil 210 and the GTA 221 must be in communication with the VTA 201 both prior to and during charging. In this example, the VTA 201 is mounted on the underside of the electric vehicle chassis 214. Each VTA 201 and GTA 221 must be aligned and paired before charging can be initiated. In the FIG. 2B example, shown is a pairing 220 of the single VTA 201 and the single GTA 221.

Before the charging signal 215 can be initiated, reverse link 216 and forward link 217 data path are established as described, for example, in U.S. Pat. No. 10,826,565 entitled “Near field, full duplex data link for resonant induction wireless charging,” incorporated herein by reference. The inductive communication links 216 and 217 are power limited with symmetric approach range 218 and departure range 219 both slightly (+/−50%) exceeding the size of the GTS's power coil 213 (approximately 500 millimeters in this example). Additional information on the alignment process can be found in U.S. Pat. No. 10,814,729, entitled “Method and apparatus for the alignment of a vehicle and charging coil prior to wireless charging;” U.S. Pat. No. 10,193,400 entitled “Method of and apparatus for detecting coil alignment error in wireless inductive power transmission;” and U.S. Pat. No. 10,040,360 entitled “Method and apparatus for the alignment of vehicles prior to wireless charging including a transmission line that leaks a signal for alignment,” the contents of which are incorporated herein by reference.

In a modular GTS, each of the single (or multiple) GTA and VTA pairs 220 communicate independently. This independent communication allows for fastest alerting in case of a fault condition and removes the need for inter-GTA (and inter-VTA) communication.

Other configurations of communication between the VTA 201 and GTA 221 may include alternative short range local area wireless networking technologies (e.g., BLUETOOTH®, Zigbee, WI-FI®) or longer range Wireless wide area network (WWAN) technologies (e.g., cellular technology such as LTE, 4G, 5G or 5G-advanced; “Connected Car” wireless packet data networking; satellite-based uplink/downlink technologies).

Immediately prior to, during, and immediately following a wireless charging session, the VTA's full duplex, low latency, near field data link controls a resonant induction, wireless power transfer system for recharging EVs. A VTA 201 is paired with respect to a GTA 221 to receive a charging signal. The VTS includes one or more VTAs 201, with each VTA 201 of the VTS having an independent full duplex inductively coupled data communication system that communicates with a paired GTA 221.

A GTS can include one or more GTAs 221, with each GTA 221 also having a full duplex inductively coupled data communications system. The GTA power coil 213 of the GTA 221 and the VTA power coil 210 of the VTA 201 are selectively enabled based on geometric positioning of the VTA 201 relative to the GTA 221 for charging.

As appropriate, the transmit/receive system of the GTA 221 and/or the VTA 201 are adjusted to be of the same type to enable communication of charging management and control data between the GTA 221 and the VTA 201 during charging.

### FIG. 2C

An exemplary sedan-style electric vehicle 223 is depicted in FIG. 2C with a single VTA 201 comprising the VTS 224. This VTS 224 configuration is called a 1×1 configuration.

### FIG. 2D

An exemplary passenger or cargo van-style electric vehicle 225 is depicted in FIG. 2D with a two inline VTAs 201 comprising the VTS 226. This VTS 226 is called an in-line, 1×2 configuration.

### FIG. 2E

An exemplary transit van type electric vehicle 227 is depicted in FIG. 2E with a two side-by-side VTAs 201 comprising the VTS 228. This VTS 228 is called a 2×1, side-by-side configuration.

### FIG. 2F

An exemplary transit van type electric vehicle 229 is depicted in FIG. 2F with a three in-line VTAs 201 comprising the VTS 230. This VTS 230 is called an in-line 1×3 configuration.

### FIG. 2G

An exemplary bus type electric vehicle 231 is depicted in FIG. 2G with two sets of two side-by-side VTAs 201 comprising the VTS 232. This VTS 232 is called a 2×2 configuration.

### FIG. 2H

An exemplary bus type electric vehicle 233 is depicted in FIG. 2H with 3 sets of two side-by-side VTAs 201 comprising the VTS 234. This VTS 234 is called a 2×3 configuration.

Larger (more than six VTAs per VTS) VTSs are possible, limited only by the size of the vehicle. The position on which the VTA(s) are mounted on the vehicle can vary. The representative examples included herein in FIGS. 2C-2H assume only that the VTA(s) are mounted symmetrically in regard to the vehicle's centerline or are consistently offset in the right or left directions and spaced to match the mirrored configuration of the GTS (or subsection of the GTS). Placement of the VTS forward of the first (from the front) axle, behind the front axle, mid-chassis, in-front of the rearmost axle or behind the rearmost axle is not limiting to the use of guideline antennas to direct the vehicle to the GTS.

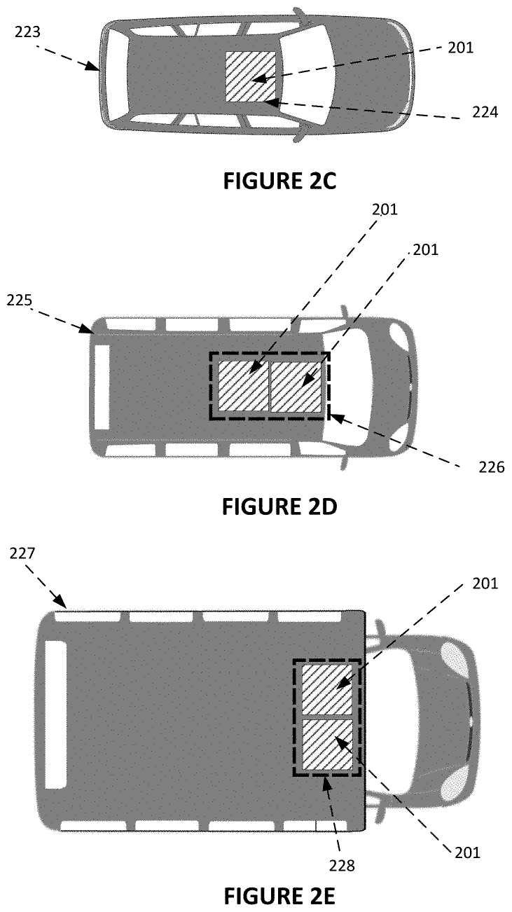

### FIGS. 3A-3C

FIGS. 3A, 3B, and 3C show alternative examples for vehicular guidance based on a signal transmitted from a single span or multiple spans antenna. These antenna guidelines can enhance or replace visual indicators for guidance of electrical vehicles to the wireless charging station. FIGS. 3A, 3B, and 3C each show the guidance signal as originating within the GTA circuitry. In an alternative conceptualization, the guidance signal generation can occur in a separately installed transmitter albeit at the cost of a separate weatherproof enclosure from an enclosure housing the GTA circuitry and provisioning of a communications interface (for activation and control of the guidance signal) with backhaul to the station controller either via a datalink with the served GTS or other wired or wireless means. By having one guidance transmitter per GTA 221, any GTA 221 in the GTS 220 can provide signaling to the guideline antenna, reducing GTA model variability.

### FIG. 3A

FIG. 3A depicts a common configuration for a Ground Transceiver Assembly (GTA) 301 used in the construction of modular GTAs 220 that make up a Ground Transceiver Station (GTS). In FIG. 3A, the GTA 301, in addition to housing the power transfer coil and associated electronics 302, is designed to support a single antenna cable for guidance purposes (a “guideline”) by inclusion of a radio transmitter 303 that transmits a guidance signal. This radio transmitter 303 is used for generation of a guidance signal which is emitted on the connected guidance antenna 304. The connected guidance antenna 304 is designed to be fastened to the surface of the pavement or embedded within the pavement with a radio permeable covering in each case. The guidance signal is preferably a reactive near-field signal. Reactive near-field signals are non-radiating signals that expand and contract, emanating from the source.

A suitably-equipped electric vehicle (EV) or hybrid electric vehicle (not shown) makes use of two or more induction antennas (e.g. inductive loop antennas, flat panel antennas, chip antennas) that receive the signal from the guidance antenna 304 and processes it as described in FIGS. 2A and 2B. Guidance is provided by the received signal, having an amplitude and phase, that is detected using one or more pairs of receiver antennas to align the vehicle left-right in the parking slot, lane, or designated charging area when the vehicle is approaching the GTA 301.

### FIG. 3B

FIG. 3B depicts an enhanced common configuration for a Ground Transceiver Assembly (GTA) used in the construction of modular Ground Transceiver Stations. In FIG. 3B, the GTA 301 includes a transmitter 303 for generation of the guidance signal for a guideline with said transmitter connected to the mid-point feed 305 of a center-fed dipole antenna 306 with a first span 307 and a second span 308, where each span has an electrical length that is approximately one quarter of the wavelength of the transmitted guidance signal. The dipole antenna 306 is fastened to the surface of the pavement or embedded within the pavement with a radio permeable covering in each case.

The EV (not shown) makes use of 2 or more receiver antennas to receive the signal and process them as described in FIGS. 2A and 2B. Alignment feedback is determined by the utilizing the guidance signal emitted from the first guideline antenna span 307 and second guideline antenna span 308 with said signal having an amplitude and phase that are detected using paired antennas to align the vehicle left-right in the parking slot, lane, or charging area when the vehicle is approaching the charging induction coil 302. By using the known signal frequency, measured amplitude and measured phase for each of the first span 307 and second span 308, the vehicle range to the GTA 301 can be estimated. The phase difference will be zero when the first receiver antenna pair (not shown) reaches the mid-point feed 305 on the centerline 310 of the center-fed dipole antenna 309 guideline. At this point, the short-range communications link between the VTA (not shown) and GTA 301 is established and provides final positioning,

### FIG. 3C

FIG. 3C shows a GTA 301 equipped with a guideline consisting of a folded, end-fed wireline dipole antenna 311. At one end of the folded dipole guideline antenna 311 is the GTA 301, which hosts the transmitter 303. The centerline 310 of the GTA 301 shows the y-axis point where the corresponding vehicle's VTA (vehicle transceiver assembly) resonant inductive coil center should be positioned for maximum wireless power transfer efficiency. The folded, end-fed dipole antenna 311 extends a distance 312 away from the GTA in a direction opposite the direction of approach to the limit of approximately 1/4 the electrical wavelength of the guidance signal. The curved end 303 of the folded end-fed, guideline antenna 311 serves as the signal acquisition point where the vehicle-mounted receiver antennas can reliably detect the transmitted guidance signal regardless of the vehicle angle of approach, indicating the beginning of the antenna 311.

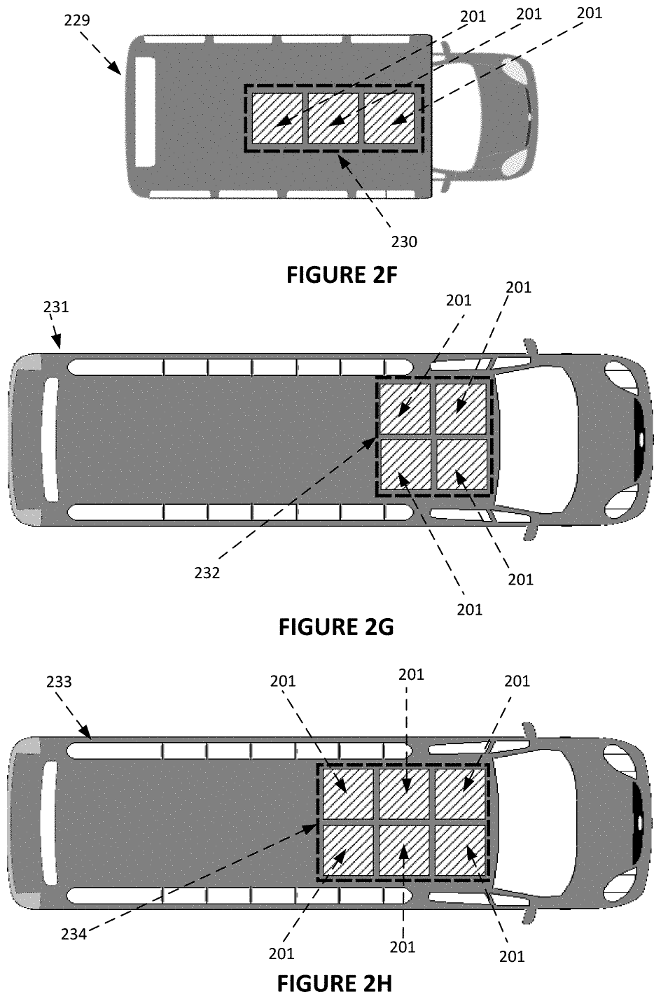

### FIG. 4A

FIG. 4A illustrates an example configuration of a GTS 401 with two side-by-side (2×1) GTAs 402 and 403. Guideline antennas 404, 405 extend from the respective GTAs 402, 403 to a distance 406. The EV will approach the GTS 401 over this distance 406. The guideline can be any of the guidelines described in FIG. 3A, 3B, or 3C.

In one configuration for providing guidance to a single VTA equipped EV, the charging station controller (see FIG. 1) commands only one of the first guideline antenna 404 or second guideline antenna 405 to transmit, at a specified frequency, to the EV's receive antennas. At least two of the vehicle-mounted antennas (not shown) mounted on opposite sides of transmission line when the vehicle is aligned in the parking slot detect and measure the transmitted signal from the guideline(s), and signal processing circuitry determines relative signal amplitude and phase between signals detected by the antennas that is representative of alignment of the vehicle with respect to the wireless power induction coil and the parking slot.

In another configuration with an EV with a matching VTS with a side-by-side (2×1) installation of VTAs, the first guideline antenna 404 transmits on a first frequency while the second guideline antenna 405 transmits on a second frequency with both signals sharing the same amplitude. This allows the VTS to acquire either or both signals and use them to guide the EV. This approach would also require additional transmission facilities over the single radio, single active antenna guideline scenario.

For an EV with multiple VTAs, the 2×1, side-by-side GTS 401 can transmit power to a single side-by-side pair under the direction of the charging station controller or vehicle BMS or negotiated between them. For example, an EV with a single VTA can be guided to and charged on a 2×1 GTA GTS as can the inline 1×2 or 1×3 GTS equipped EVs. Such mismatched GTS-to-VTS would result in the GTA using only the single paired GTA and VTA for charging.

Larger VTSs with VTA sets such as a 2×2 or 2×3 can also be guided to and charged by the 2×1 GTS but will only be charged using whatever VTA-GTA pairs can be aligned resulting in a lower maximum charge rate using the power transfer of only paired sets of GTA and VTAs.

### FIG. 4B

FIG. 4B shows an illustrative guideline configuration of a GTS 407 with two inline (1×2) GTAs 408 and 409. A single antenna guideline 410 extends from the first GTS 409 to a distance 411. The EV will approach the GTS 407 over this distance 411.

For an EV equipped with corresponding 1×2 in-line set of VTAs (a first, front VTA and a second, back VTA) the single antenna line 410 can be used to guide the EV along the line 410 over distance 411. An antenna sensor pair mounted on the first VTA or multiple pairs of antenna sensors mounted on the first and second VTA can be used to determine Right-to-Left offsets and corrections.

Once the EV's front VTA of the approaching electric vehicle is in communications with the back GTA 408 and the back EV VTA of the approaching electric vehicle is in communications with the front GTA 409, the guideline antenna 410 can be disabled. The VTS-to-GTS communications may use the inductive communications system described in U.S. Pat. Nos. 10,040,360 and 10,814,729 to the present assignee, the contents of which are incorporated herein by reference. Such a short-range antenna system will allow communications for at least one pad width (˜750 millimeters in this example), so the second VTA can hear the first GTA once the first VTA has reached the 1×2 in-line VTA charge point at GTS 407.

Both EVs with a single VTA or a set of 1×2, in-line VTAs can be guided to and charged at full rate via the 1×2, in-line GTS 407. The station controller can select which GTAs 408, 409 would be used to charge the EV with a single VTA. Larger VTS installations such as a 2×2 or 2×3 can also be guided to and charged by the 1×2 in-line GTS 407, but only at the power of the two paired sets of GTA and VTAs.

### FIG. 4C

FIG. 4C shows an exemplary configuration of a 2×2 GTA GTS 412. In the 2×2 GTS 412, the four GTAs 413, 414, 415, and 416 can enable charging of single VTA-equipped EVs as well as EVs with 1×2, 2×1 and 2×2 VTA equipped VTSs. EVs with larger VTS installations (e.g., 2×3, 2×4, 3×6 VTAs) can also be charged via whatever GTA-VTA pairs are active and align properly.

The Ground Transceiver Station (GTS) 412 is equipped with first and second guideline antennas 417, 418 originating at the first GTA 414 and second GTA 416. By controlling the signaling transmitted on each guideline 417, 418, the station controller (not shown) can direct the charge point to guide the EV dependent on the VTS configuration equipped on the EV.

Single VTA equipped EVs may be directed to any GTA 413, 414, 415, 416 in the GTS 412 by selectively enabling a signal on a guideline antenna 417, 418 for reception by the VTS-mounted (e.g. inductive, near-field) antenna system and then using the communications system from any GTA to cause the EV to be positioned. In one operative example, an EV with a single VTA receives the signal from the first guideline antenna 417. Traveling along the guideline, the EV steers to align the VTS's centerline with the guideline 417. Once the charge point is reached (as indicated by reception and processing of the short-range GTA inductive communications signaling), the EV comes to a stop with its VTA positioned over GTA 415 or 416 (whichever is selected by the charging station controller according to the selection algorithm (e.g., selecting the least used, most used, most recently not used, coolest in temperature)). Once positioned, the exchange of alignment verification messaging can be accomplished, and charging started between the verified aligned GTA and VTA.

In an alternative example, a charge point 412, with a GTS consisting of 4 GTA arranged in a 2×2 grid, is tasked with charging an incoming EV with a VTS consisting of 6 VTAs arranged in a 2×3 grid symmetric across the centerline axis of the EV.

In this example, both the right 417 and left 418 guideline antenna carry separate signals (separate in carrier frequency, in channels (time and/or frequency), pulse code groups, or separated by coding groups (as in a Direct Sequence Spread Spectrum (DSSS) technique with both antennas 417, 418 having the same carrier frequency or different frequencies). At least one VTA on the right side detects and measures the signal from the right guideline antenna 417. At least one VTA on the left side detect and measure the signal from the left guideline antenna 418. With each VTA equipped with a pair of inductive loop antennas, each VTA involved can minimize the difference in received signal amplitude. Using the signals one or both antenna lines 417, 418, the EV is guided over the distance 419. At least one VTA then detects the broadcast from the enabled GTS beacon. In the 2×3 example, the GTS beacon can be broadcast from the first GTA 415 or second GTA 413 depending on whether the right 417 or left 418 guideline is used. The vehicle comes to rest with the VTA corresponding to the selected GTA 413, 415 positioned overhead.

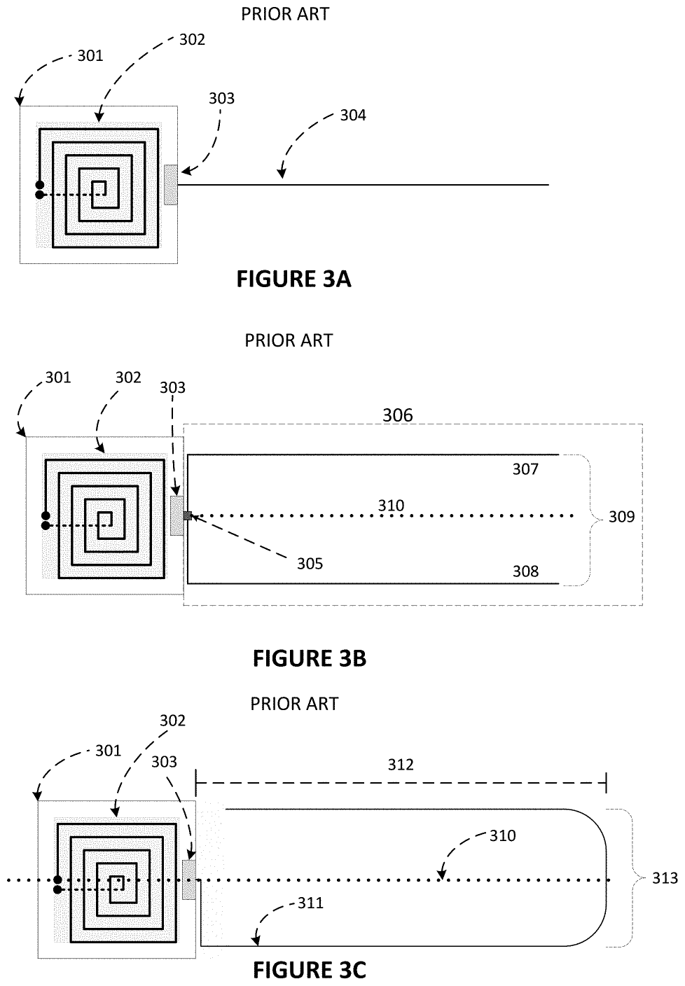

### FIG. 5A

FIG. 5A shows the use of a long-line (multi-wavelength) guideline antenna cable 511 configured to direct the approach of the EV.

In this configuration, a modular GTS 501 contains multiple GTAs 502, 503, 504, and 505. From the first GTA 503 and second GTA 505 on the approach side project two guidelines (both comprised of center-fed dipole antennas in this example). The first dipole antenna from the first GTA 503 has antenna spans 506 and 507 and the second dipole antenna from the second GTA 505 has antenna spans 508 and 509. The dipole antenna spans extend 1/4 wavelength of the guidance signal over the distance 510.

To allow longer approach guidance, a third radio signal transmitter is included in the GTS 501 and a long antenna element 511 is placed to extend over distance 512 and 510. This long line, third signal antenna broadcast is made discernable from the shorter guideline antenna broadcasts by a separation in frequency (i.e., frequency division), time (i.e., time division), or signal coding. Signal coding may include differing modulation schemes (e.g., Amplitude Shift Keying (ASK), Frequency Shift Keying (FSK), or Phase Shift Keying (PSK) signaling) or differing spreading code for Direct-Sequence Spread Spectrum (DSSS). The EV, using inductive loop receivers, for example, can acquire and follow line 511 using the emitted third signal. In a transition zone 513, the EV will need to acquire the guidance signal(s) transmitted from GTA 505 and/or GTA 503 dependent on the VTA configuration mounted on the EV and conveyed by the wireless local area network.

### FIG. 5B

FIG. 5B shows enhanced detail of one configuration for the operation of the guidelines in the transition zone 513. In the FIG. 5B configuration, the long antenna lines 514 and 515 are continuous for their respective lengths and may share a common trench cut into the pavement 516. Differentiation on which line to follow can be as simple as disabling signaling on either the right-side 514 or left-side 515 long line.

### FIG. 5C

FIG. 5C shows enhanced detail of another configuration for the operation of the guidelines in the transition zone 513. In the FIG. 5C configuration, the long antenna lines 517 and 518 are discontinuous for their respective lengths and a common guideline (e.g. a single antenna wire) 519 is used for broadcast from a single trench cut into the pavement. A switch 520 is used to isolate the broadcast signaling path depending on the usage of the right-side 517 or left-side 518 long antenna line. In an example configuration, the switch is directed by application of a DC-offset to the broadcast signal.

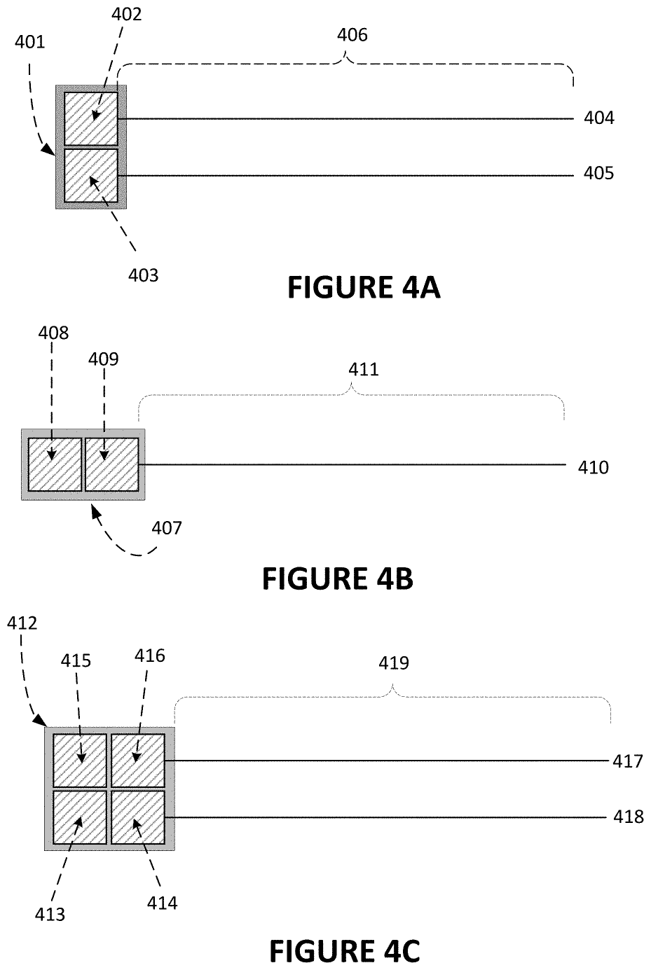

### FIG. 6

FIG. 6 depicts an exemplary parking lot equipped with wireless GTSs 609 in selected parking slots. Note that in this example, pull-in parking is assumed.

When the EV 601 has completed the navigation stage and approaches the charging station 602, it will need approach information and terminal guidance to the designated charge point.

In the driver piloted case, the EV 601 will proceed into the charging station 602 where signage and visible signals will indicate the parking slots with vacancies, wireless charging capability, and present status of the wireless charger (a GTS). Using this visual information, the driver will proceed to an empty, compatible GTS 609. Optionally, a radio communications system (not shown) may be used to broadcast or selectively transmit charge point information (e.g., charger type, charger configuration, power available, slot availability, status, wait time) to the driver via vehicle instrumentation.

In the case of an EV with a driver assistant software pilot or a fully automated EV, the charging station can communicate (via radio interface) the coordinates of the selected or negotiated compatible GTS 609. As a primary method, the EV 601 will be sent the approach line and guidance line frequencies for the parking slot. Multiple selectively enabled approach lines (or a multi-frequency line) are termed a trunk line.

The first charge point 607 has the first approach line 613 and first guidance line 614 associated with it. The second charge point 605 has the first approach line 615 and first guidance line 616 associated with it. A third charge point 604 has the third approach line 611 and the third guidance line 612 associated with it.

In an illustrative configuration, the EV 601 is sent to the destination GTS slot 605 via the sequence of approach and guidance. The EV 601 is told to first follow line 610 at a restrictive velocity. In this example, the trunk 610 is the main guidance line and can support multiple guidance signals via selective enablement of individual buried line(s) or switching. At the acquisition point 603, the approach line signal is at its minimum value, which is above the detection threshold of the inductive receivers.

Once on the trunk line 610, the EV via the VTS-based inductive receivers steers to follow the trunk line. When the selected approach line 615 splits off the main trunk 610, the EV 601 again follows the line via the VTS-based inductive receivers. Once the guidance line segment 616 is reached, the vehicle is slowed further and steering adjustment precision is increased as to result in the EV 601 coming to rest with its VTS array precisely over the charge point's GTS 609, such that the VTA/GTA pairs are sufficiently aligned.

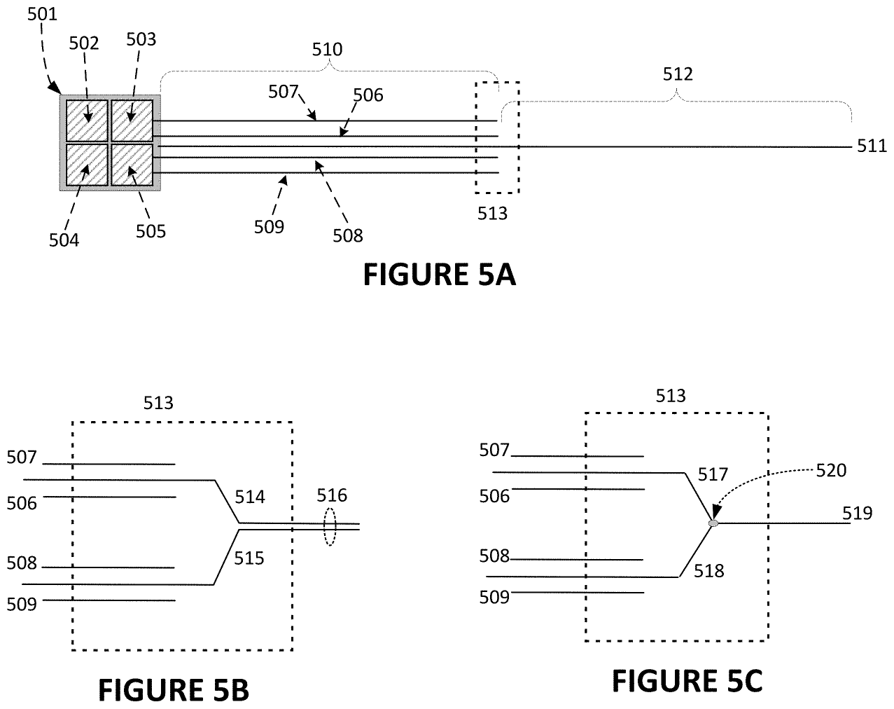

### FIG. 7

FIG. 7 shows a configuration of the vehicle guidance system for wireless power transfer positioning for an exemplary 2×2 GTS using both a long (the long antenna may be shorter or longer than a full wavelength (dependent on the selected frequency and deployment) transmission line 704 to provide approach guidance over a first distance 706 and a left center-fed dipole antenna 702 and a right center-fed dipole antenna 703 to provide guidance and range to the GTS 701 over the second distance 705.

In one configuration of FIG. 7, a beacon signal is continuous on the long line 704 and a second and/or third beacon signal is continuously transmitted by the left and/or right dipole antennas 702, 703.

Dependent on the need to steer the vehicle straight, left or right, a second and/or third beacon using frequency, modulation, or code will be transmitted on the left guideline 702, the right guideline 703 or both. The frequency, modulation, or spreading code of the beacon allows differentiation of the guidelines. Inactive guidelines can remain disabled, and no beacon transmitted.

In the FIG. 7 configuration, an end-of-line short range (e.g. RFID, Zigbee, 802.11 (WI-FI®), BLUETOOTH® and inductive (near field) coupling)) transmitter 707 also may be included.

The end-of-line (EOL) transmitter 707 may replace, supplement, or backup a longer-range communication system. This is seen as especially useful for a lone GTS installation, or low-density charger stations with few GTSs. The EOL transmitter 707 may include a transmitter, a processor, and a memory as well as a wired communications subsystem for receiving data from or via the GTS 701 via the long line cable 704. This EOL transmitter 707 may broadcast its location (latitude and longitude) and the capabilities of the charging station (e.g., power levels offered, payment forms available (e.g., virtual wallets support, online account(s) supported, memberships supported, credit, debit, club cards), etc.). The EOL transmitter 707 also may convey via signaling the frequency, modulation, and coding of the signal from upcoming guidance line(s) 702, 703 to best match the active GTA configuration with the vehicle's VTA configuration.

The EOL transmitter unit 707 also may be powered via the long guidance line 704 using a DC offset to the beacon signal(s).

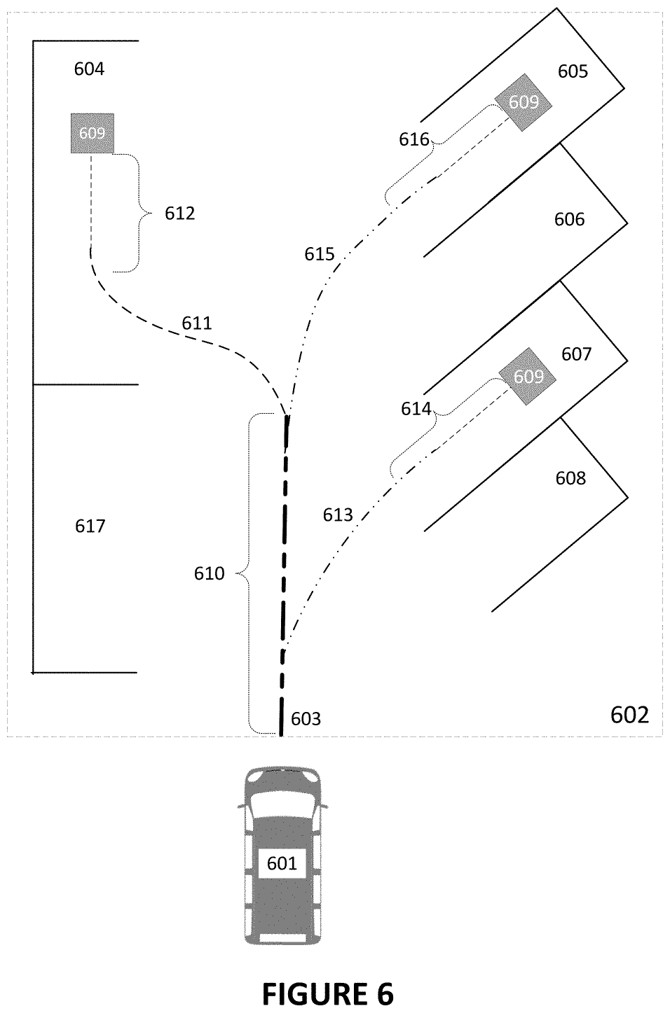

### FIGS. 8A-8B

FIG. 8A shows the elements of a GTS 801 that supports guidance from two directions. FIG. 8A uses four GTAs 802, 803, 804, and 805 to construct the GTS 801, each GTA 802, 803, 804, and 805 can be dynamically configured to support multiple vehicle VTS configurations. For a first distance 806, a first right guideline 807 and a first left guideline 808 extend from the GTS 801. For a second distance 809, a second right guideline 810 and a second left guideline 811 extend from the GTS 801. Shown here as straight line, the guidelines 807, 808, 810, and 811 also may be curved for some or all of their respective lengths.

Alternative GTS configuration providing guidelines over the first distance 806 and second distance 809 are possible. A 1×2 inline GTS 801 with a first and second guideline antenna would require no modifications to the GTAs. A GTS with a single GTA would require the addition of a second guideline transmitter. A 2×1 GTS could use the unmodified GTA with a single guideline per GTA, resulting in a first distance with a single right or left guideline and a second distance with a corresponding but differing left or right guideline (since each unmodified GTA supports only a single guideline transmitter).

In all cases having a GTS with two guideline antennas allowing for alternative approaches (e.g., 2×1, 2×2, 2×3), the same guidelines could be used for directing an approach and a departure with the approach guideline being switching off before the charging session and the departure line being switched on after the charging session.

FIG. 8B depicts a first curbside parking space 816 with a resident GTS 801. The parking space 816 is oversized in this example, with the potential for a front-mounted (nominally behind the front axle), mid-mounted, or rear mounted (nominally directly in front of the rear axle) VTS. The curb 814 defines one side of the parking space 816 with visual line markings (not shown) defining the other sides. In FIG. 8B, the guideline may be comprised of single or multiple antennas 812, 813.

Additional charger equipped parking spaces 817, 818 may be located along the curb 814. These additional charger-equipped parking spaces 817, 818 with the first charger equipped parking space 816 may comprise a charging station and may be under common ownership and control.

A first approach line antenna 812 is attached to a first guidance line 806. The first guidance line 806 connects to the GTS 801. A second approach line 813 is connected to the GTS 801 by a second guideline 809.

Assuming a direction of travel 815, an EV can use a pull-in technique with approach line 812 and guideline 806 to position correctly over the GTS 801 regardless of the EV's VTS mounting position on the underside of the vehicle chassis (e.g., front, middle, rear positions).

Alternatively, assuming a direction of travel 815, an EV can use the back-in technique approach line 813 and guideline 809 to position correctly over the GTS 801 regardless of the EV's VTS grid mounting position on the underside of the vehicle chassis (e.g., front, middle, rear positions).

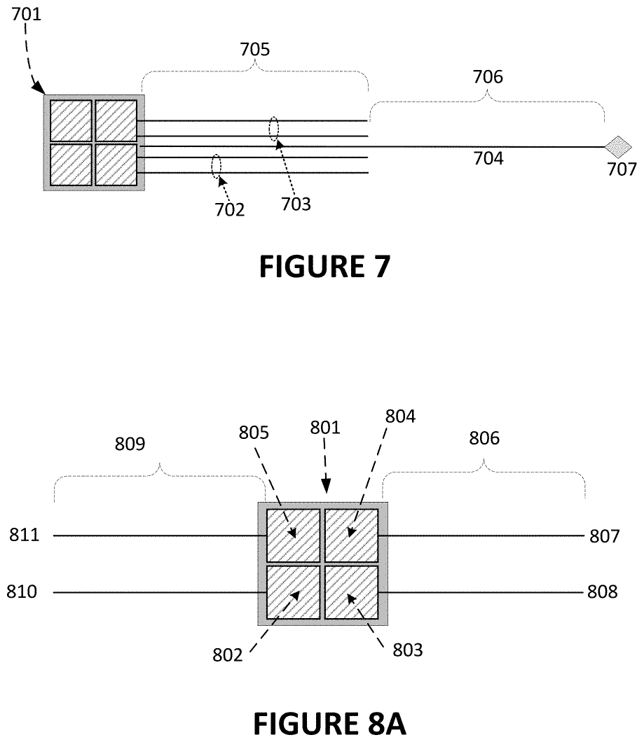

### FIG. 9

FIG. 9 illustrates an EV charging station 901 for a country or region where back-in parking is the norm. GTS positions within individual parking slots 904, 905 may be varied to support forward, midpoint, or rear mounted VTS installations. In the FIG. 9 example, the available parking space 905 has a GTS 902 situated for a front mounted VTS installation.

For an EV proceeding in the direction of travel 909, the trunk guideline 903 splits into individual guidance lines 907, 908. Once the split has been detected by lack of continued signal detection in the forward direction, the EV 906 will reverse to follow the selected guidance line 907 or 908 to the designated parking space 904 or 905 and resident GTS 902 whereupon final alignment will occur.

The backed-in EV 906 will charge until the session is completed at the selected state-of-charge. The guidance and approach lines for the parking space 904 may then be re-activated to direct the EV 906 to the exit of the EV charging station 901.

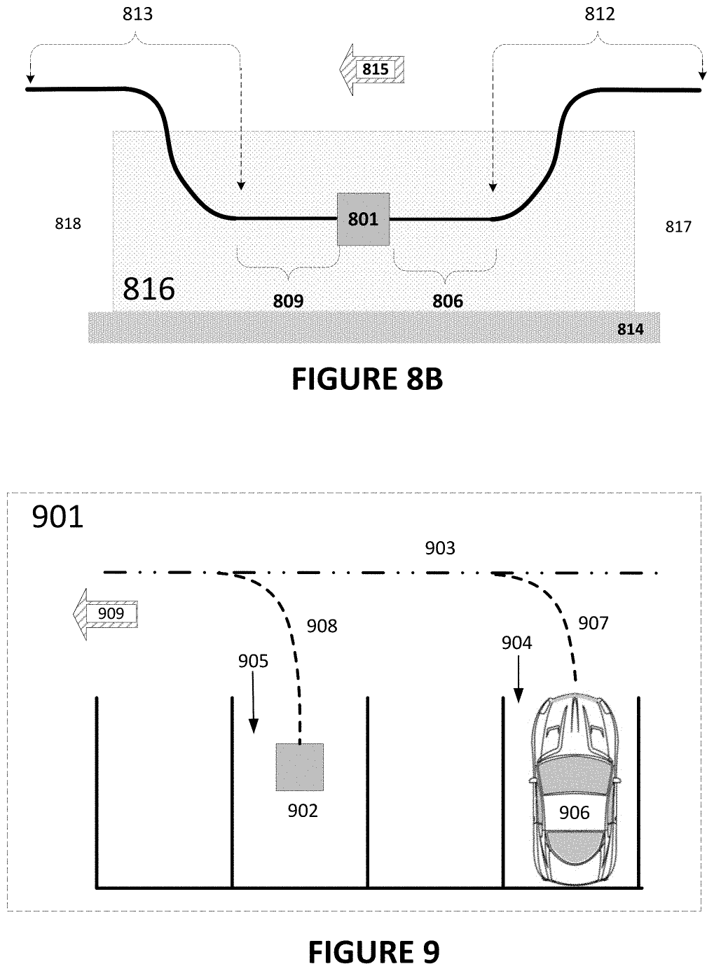

### FIG. 10

FIG. 10 illustrates, at a high level, the EV systems involved with automatic wireless charging in example configurations. As illustrated, the EV 1001 is equipped with a Vehicle Transceiver Station (VTS) 1002 (in this case a single VTA). The Battery Management System (BMS) 1003 is responsible for monitoring and management of the energy storage system 1004. Based on algorithms, the BMS 1003 manages performance and maximizes range and longevity by setting charge rates and balancing individual cell (or cell bank) charging/discharging while monitoring charge levels and mitigating temperature extremes to increase battery service life of the battery 1004. The energy storage system 1004, nominally a rechargeable chemical (e.g., Lithium ion) battery, but also could be a one or more of a capacitor bank, reversable fuel cell, solid state battery or a hybrid combination of the aforementioned.

The BMS 1003 controls the charging session (and associated logistics, billing, and sensor reading) with messaging sent via the forward datalink 1005 and reverse datalink 1006 supported by the inductive communications transceiver system provided by the VTS 1002 (in this example, the VTS 1002 is a single VTA). A data store of the BMS 1003 includes identity and authorization information, battery voltage, and a maximum current level setting. The wireless charging controller 1007 functions to translate and bridge the vehicle network and the inductive communications transceiver system via data link 1008, which may be, for example, implemented as a wireless or wired Controller Area Network (CAN) bus. The BMS 1003 measures sensor data from the battery 1004 via wired (or wireless) connections 1009. In some configurations, the wireless charging controller 1007 may be implemented as a software package running concurrently on the BMS 1003 processing and data storage hardware, thus foregoing need for the illustrated controller 1007 to BMS 1003 data bus(s) 1008.

The VTS 1002 delivers direct current to the battery pack 1004 via a high-current power feed 1010. In cases where the battery pack 1004 is charging or fully charged current also may be diverted or shared with onboard systems of vehicle 1001, such as communications, entertainment, and environmental control while aligned and in communications with the GTS.

The EV controller module 1011 (which can include feeds to the EVs displays, a driver assistance system, or an autonomous driving system) may obtain status, alarm, and charging-related information from the BMS 1003 via a wired or wired datalink 1012 (e.g., a CAN bus) or the wireless charging controller 1007 via a wireless (e.g., Zigbee) or wired datalink 1013 (e.g., a CAN bus). Not shown are the data connections between the driver electronics 1011 and the EV's 1001 own radio communications antenna 1014 or the Global Navigation Satellite System (GNSS) (e.g., GPS, Galileo, GLONASS, BeiDou) antenna 1015 emplaced on the EV 1001.

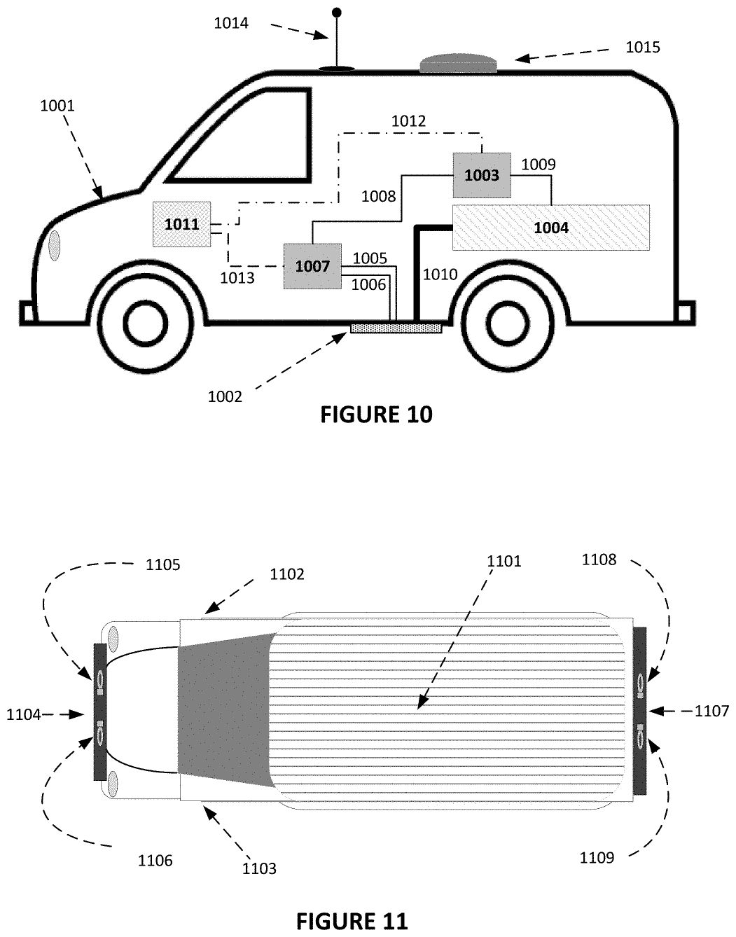

### FIG. 11

FIG. 11 depicts an exemplary installation of an inductive antenna for the reception of approach, guidance, and alignment signals. As described in U.S. Pat. No. 11,121,740 to the present assignee, the contents of which are incorporated herein by reference, the inductive antenna coils may be installed in symmetric pairs on the VTAs mounted on the underside of the EV 1101 to act as sensor pairs for the collection of guidance signals.

Mounted as far forward as possible (shown here in the radio-transparent front bumper cover 1104), the optional front sensor pair 1105, 1106 at front bumper 1104 serve to extend the range of the inductive sensor set 1105, 1106 forward to assist in pull-in parking scenarios. The forward pair of sensors 1105, 1106 also allow for earlier signal acquisition of the extremely short-range signal from the ground-mounted guideline antenna(s) (not shown).

Another favorable position for installation of auxiliary sensors is under or within the rear bumper cover 1107. The rear right sensor 1108 and rear left sensor 1109 not only give a longer baseline between (VTA mounted or front mounted) sensors, but also act as the leading sensors in back-in parking charging situations.

With a single VTA, there will be at least one pair of right 1102 and left 1103 sensors. Additional VTS associated sensor pairs can be present either from additional VTAs in the VTS or equipped on the VTA.

Connected to the VTS via wired (e.g., via CAN bus (ISO 11898)) or wireless connections (e.g., via Zigbee (IEEE 802.15.4)) , auxiliary sensor pairs can be deployed. Favorable positions include under the front bumper cover 1104 where forward right sensor 1105 and forward left sensor 1106 are sited to give earliest reception of the guideline broadcast. Dependent on the radio transparency of the material used for the bumper and bumper covers, the inductive loop antenna could be embedded within the bumper structure.

The VTS (as detailed in FIG. 2A and FIG. 2B) mounted sensor pair 1102, 1103 not only provide a set of differential reception points to gauge the centerline for approach, but also enable VTS-to-GTS alignment measurement.

The optional rear mounted antenna pair 1108, 1109 serve to extend the range of the inductive sensors to the rear for back-in charge point scenarios.

Using multiple pairs of inductive antennas together as sensors for guidance signals allow calculation of the direction of travel (using the signals from guidance antenna(s)). Such angle of approach information can be displayed to the driver or delivered to a driver assistance or driver automation system. Angle information can serve to simplify the approach, guidance, and alignment process since it allows calculation of the predicted path and can be used to correct steering angles and (when coupled with range and speed (as determined by the rate of range reduction or delivered from the EV) set braking.

FIG. 11 assumes the nominal scenario where the VTS is mounted on the underside of the vehicle in symmetric grid fashion on or in parallel with the vehicle centerline. In some WPT scenarios, the need to offset the VTS from the centerline is required due to EV construction. Compensation either in the calculation of the approach and guidance or in sensor placement can be made to accommodate such EVs without modification to charging stations and GTS's guidance and approach antenna(s) based on the symmetric VTS mounting assumption. Also contemplated are vertical placement of the VTS (e.g., on the side, front, or back of an EV such as a bus or ferry) with the corresponding GTS mounted on a wall, loading dock, or roadway separator. Top-mounted VTS can be of benefit for EVs with rough-road or off-road duties. Corresponding GTS installations would necessarily need to be ceiling or gantry mounted with actuators to provide clearance and VTA-GTA gap distance adjustments.

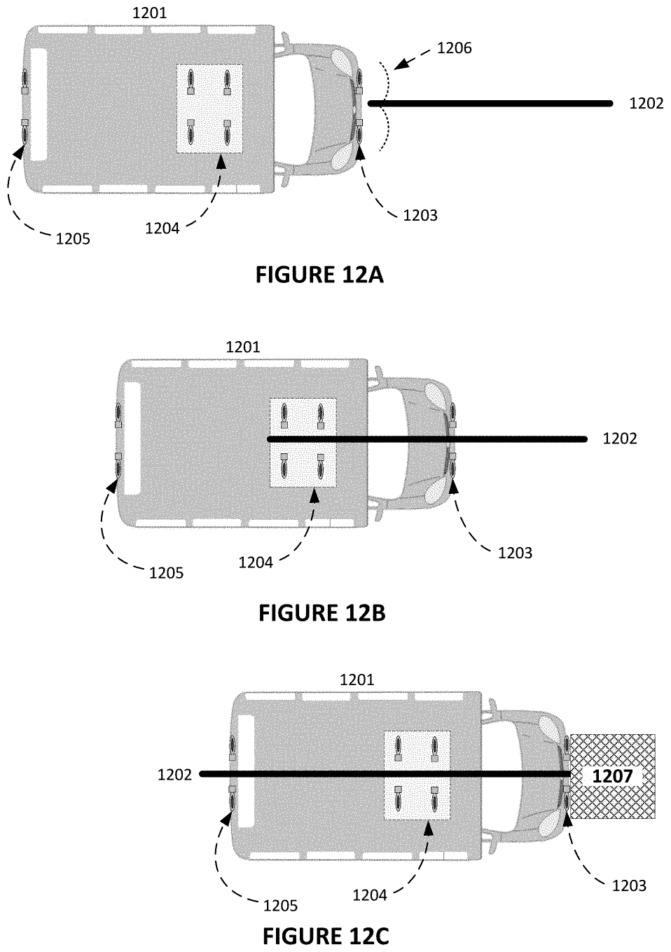

### FIGS. 12A-12C

FIGS. 12A, 12B, and 12C depict the approach of an EV to a wireless charger (or departure from) using an inductive guideline and vehicle-mounted inductive loop receivers.

In FIG. 12A, the EV 1201 has just acquired the guideline 1202. The front pair of receivers 1203, shown here as embedded on the lower bumper cover, means reception at the start of the approach under guidance is limited by the short-range limitation of receivers 1206. Despite the range limitation, the front receiver pair 1203 collected signals can be used for right-to-left alignment determination based on processing of signal amplitude and phase which can begin immediately after acquisition. The two sensor pairs mounted on VTS 1204 and the rear bumper mounted sensor pair 1205 do not play a role in forward acquisition when a front receiver pair 1203 is equipped.

If the EV 1201 approaches the GTS in reverse (i.e. backing up), then the roles of the front sensor pair 1203 and rear sensor pair 1205 are reversed during acquisition.

In FIG. 12B, the EV 1201 is under guidance. At the time shown, the front sensor pair 1203 and sensors mounted on the VTS 1204 (2 pair of sensors are shown in this configuration) are all receiving the guideline 1202 signal and contributing to right-to-left steering information. Due to the near field signaling range and the long wavelengths of the radio signal versus the maximum baseline provided by the length of the vehicle, only the amplitude and phase of the signal contribute to determination of the right-to-left offset. With the multiple sensor pairs, mounted a known distance apart, the right-to-left offsets can be used to determine a steering correction angle.

In FIG. 12C, the EV 1201 is under guidance and the front sensor pair 1203 has reached the end of the guideline which is the edge of the GTS 1207. Upon detecting the forward datalink signal (not shown) from the GTS 1207, the front receiver pair 1203 leaves the approach state and moves to the alignment state. The additional sensor pairs (the pairs mounted on the VTS 1204, and the pair mounted under the rear bumper 1205) continue to supply received phase and amplitude of the guideline signal until the sensor pair(s) on the VTS 1204 enter the alignment state.

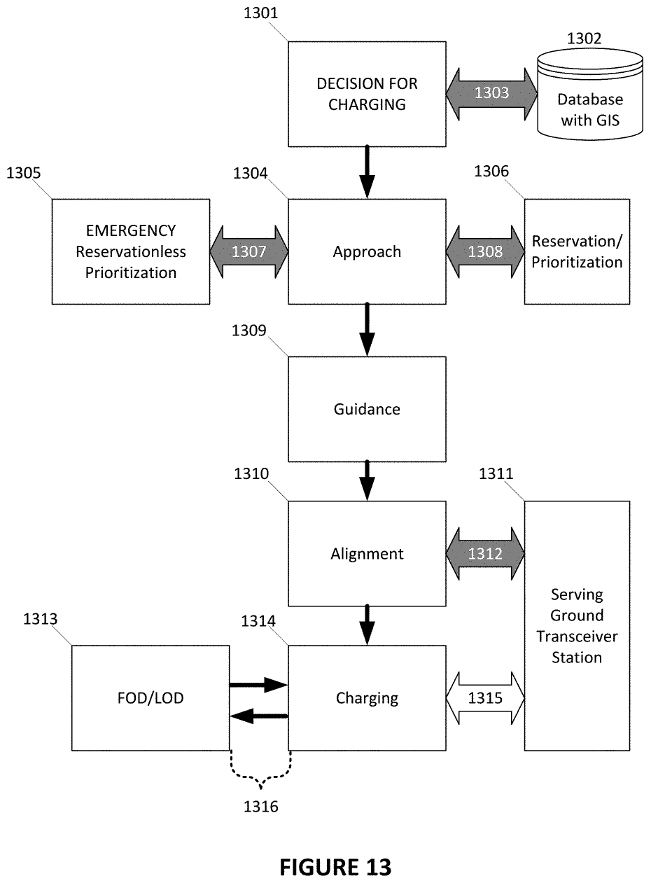

### FIG. 13

FIG. 13 shows an exemplary system for wireless charging of an EV. Automatic wireless charging of an EV may involve multiple stages given the nascent state of the infrastructure. A staged approach is considered that serves public access, private fleet usage, and mixed usage. The FIG. 13 depicted solution uses a mix of logical and functional elements as well as communication systems.

Stage 1 includes Navigation 1301 and includes trip planning, the determination of a desirable, compatible GTS availability near the destination or along the travel route, and reservation of a compatible charger (e.g., a Ground Transceiver Station (GTS) with a configuration of Ground Transceiver Assemblies (GTAs) that best match the vehicle's Vehicle Transceiver Station (VTS) configuration of Vehicle Transceiver Assemblies (VTAs)).

Since the need to recharge is at the driver's (driver in this case means human, driver assistance systems, and/or autonomous driving systems) election, this reservation can take place hours or days prior to a trip or once the EV has entered the charging station area, a flexible architecture is needed. Since multiple Charging Station owners will exist, a federated data architecture is used (where the data on charger availability is stored in a heterogeneous set of autonomous data stores which are made accessible to data consumers as one integrated data store by using on-demand data integration). To support the Decision for Charging (Navigation) 1301, the trip planning tool requires access to the Geographic Information System (GIS) enabled federated database 1302 housing charger station GTS information as well as local and potentially pre-existing reservation status for the GTSs. The communication link 1303 between the planning tool and the database 1302 is a generic wired or wireless packet datalink (e.g., wired Internet or wireless packet data).

Stage 2 includes Approach 1304 and involves direction of the EV to a charge point at the GTS that is suitable for charging the EV. Approach 1304 relies on selection of a wireless charging station (at minimum) with GIS data (e.g., an EV-based mapping system). As the EV approaches, updated location and/or estimated arrival time may be provided via wireless data link 1308 (e.g., via a cellular radio network) transmitted to a reservation system 1306 (either local to the station or one that covers multiple stations).

Reservationless charging sessions may be allowed by the charging station owner. In one sample configuration, where the driver or driving system has a prior knowledge of the charging station's location (e.g., driving past signage, or past familiarity with the station) the reservation may be the first interaction in the charging process with the GTS (skipping the Navigation Stage).

Prioritization of charging resources may then involve a query (over the wireless interface 1308) for vehicle information including VTS related data, battery voltage and State of Charge (SoC) and desired SoC (if available). GTS selection could then be optimized for GTA-to-VTA configuration, time-required-to-charge, next available compatible charger, next available oversized charger (where the GTS configuration is larger than the VTS and only a subset of the available GTAs will be enabled), or next available undersized charger (where the GTS configuration is smaller than the VTS configuration, allowing only a subset of the EV's VTAs to be used for wireless charging). Reduction of wait time, reduction of charging time (due to GTS/VTS mismatch), and efficient GTS usage are all goals. In some scenarios, customers may be offered a reduced total charge (shorting charging and GTS allocation time, potentially by using an undersized GTS) in exchange for a reduced waiting time.

In addition, the charging station controller (FIG. 1) may consider customer affinity or rank in making the charger availability decision, giving additional precedence in prioritization. In one scenario, prior reservations are always given precedence and a first available (with a compatible GTS/VTS) is used for antecedent ordering for minimum wait (till charging) times. In another, a fleet customer is given a higher rank and always receive the next available charger with the highest charging ability (e.g., a GTS-to-VTS match or oversized GTS).

In another sample configuration, a private charging station for transit or school buses may allow use of their facility by appropriately (VTS) equipped emergency electric vehicles on an ad hoc basis. Emergency reservation-less prioritization 1305 could be transmitted to the station via radio interface 1307 or the station could automatically register the event using the vehicle's appearance.

In the emergency use case, the metering of electrical use would be recorded in a dedicated authorization-to-bill database. Prioritization of the emergency use could cause reprioritizations of other displaced or preempted reservations 1306. The next available GTS (again with a GTS-to-VTS match or oversized GTS) could be assigned, preempting existing GTS reservations. In some scenarios, a charging session may be aborted before completion, freeing a GTS for immediate reassignment.

Stage 3 includes Guidance 1309, which is unique to Wireless Power Transfer charge points and involves directing the EV to a stop where the vehicle-mounted Vehicle Transceiver Station (VTS) is corrected positioned (paired) with the ground-mounted GTS. In a modular GTS system, each GTA must be correctly positioned with the paired VTA for maximum energy transfer. Since the GTA and VTA can be operated in bidirectional mode, the energy transfer can be from the electrical grid (via the GTS) to the vehicle (via the VTS) or reversed with the power originating from the EV's energy storage (e.g., battery pack) transmitted by the VTS to the GTS for powering a DC or AC load (e.g., a house or work site).

Stage 4 includes Alignment 1310, which is the probing of the GTS-VTS linkage (via the inductive loop antennas mounted on the individual GTA and VTA units) to verify that each pair is correctly positioned before wireless charging can begin. The serving GTS 1311 is in communication with the EV via the inductive communication system links 1312 before the end of the Alignment 1310 stage.

Stage 5 includes the Charging 1314 where wireless power transmission is initiated. Each aligned VTA in the VTS will operate independently of the other VTAs. Each sufficiently aligned GTA, paired with an VTA, will operate independently from the other GTAs in the GTS.

Foreign Object Detection (FOD) (which may include Live Object Detection (LOD)) 1313 will be active during the duration of Charging 1314. FOD 1313 may be initiated at the end of Alignment 1310 or during if magnetic power levels exceed a threshold (for example when damaging thermal effects could occur or above a human safety threshold (e.g., IEEE C95.1-2019—“IEEE Standard for Safety Levels with Respect to Human Exposure to Electric, Magnetic, and Electromagnetic Fields, 0 Hz to 300 GHz”)). FOD-to-VTS Messaging 1316 may be over the inductive communications system or may be internal to the VTS dependent on the FOD technology employed.

Continuous full-duplex inductive communication 1312 between the GTS and VTS is maintained with separate full duplex links between active each VTA and GTA. In addition to standardized charger to EV messaging (e.g., ISO/DIS 15118-20, “Road vehicles—Vehicle to grid communication interface—Part 20: 2nd generation network layer and application layer requirements”) messaging, the inductive communications system exchanges system specific messaging 1315 for monitoring of the charging equipment status, reporting of detected changes in vehicle position (e.g., Coil-to-Coil gap height changes as vehicle is loaded or unloaded) or changes to vehicle state not conveyed by the EV's Battery Management System.

### Conclusion

While various implementations have been described above, it should be understood that they have been presented by way of example only, and not limitation. For example, any of the elements associated with the systems and methods described above may employ any of the desired functionality set forth hereinabove. Thus, the breadth and scope of a preferred implementation should not be limited by any of the above-described sample implementations.

As discussed herein, the logic, commands, or instructions that implement aspects of the methods described herein may be provided in a computing system including any number of form factors for the computing system such as desktop or notebook personal computers, mobile devices such as tablets, netbooks, and smartphones, client terminals and server-hosted machine instances, and the like. Another configuration discussed herein includes the incorporation of the techniques discussed herein into other forms, including into other forms of programmed logic, hardware configurations, or specialized components or modules, including an apparatus with respective means to perform the functions of such techniques. The respective algorithms used to implement the functions of such techniques may include a sequence of some or all of the electronic operations described herein, or other aspects depicted in the accompanying drawings and detailed description below. Such systems and computer-readable media including instructions for implementing the methods described herein also constitute sample configurations.

The functions described herein with respect to FIGS. 1-13 may be implemented in software in one configuration. The software may consist of computer executable instructions stored on computer readable media or computer readable storage device such as one or more non-transitory memories or other type of hardware-based storage devices, either local or networked. Further, such functions correspond to modules, which may be software, hardware, firmware, or any combination thereof. Multiple functions may be performed in one or more modules as desired, and the configuration described are merely examples. The software may be executed on a digital signal processor, ASIC, microprocessor, or other type of processor operating on a computer system, such as a personal computer, server, or other computer system, turning such computer system into a specifically programmed machine.

Examples, as described herein, may include, or may operate on, processors, logic, or a number of components, modules, or mechanisms (herein “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. The software, when executed by the underlying hardware of the module, causes the hardware to perform the specified operations.

Accordingly, the term “module” is understood to encompass a tangible hardware and/or software entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Those skilled in the art will appreciate that while the disclosure contained herein pertains to the provision of electrical power to vehicles, it should be understood that this is only one of many possible applications, and other configurations including non-vehicular applications are possible. For example, those skilled in the art will appreciate that there are numerous applications where customers wait in queues and it is desired to provide charging to customer electronic devices as the customer moves through the queue. For example, inductive portable consumer electronic device chargers, such as those (e.g., PowerMat™) used to charge toothbrushes, cellular telephones, and other devices may be managed as described herein. Accordingly, these and other such applications are included within the scope of the following claims.

What is claimed is:

1. A ground transceiver station (GTS) comprising at least two ground transceiver assemblies (GTAs) adapted to charge an electric vehicle via one or more vehicle transceiver assemblies (VTAs) of the electric vehicle, comprising:
a pair of side-by-side GTAs, each GTA adapted to align with a VTA of the electric vehicle;
a first guideline extending in a first direction from at least one of the GTAs a predetermined distance; and
a transmitter adapted to transmit at least one signal over the first guideline for detection by the electric vehicle for use in guiding the electric vehicle along the first guideline for alignment of at least one VTA of the electric vehicle with at least one of the GTAs.

2. The GTS as in claim 1, further comprising a second guideline, wherein the pair of side-by-side GTAs are oriented perpendicular to the first direction, a first GTA is connected to the first guideline, the first guideline extending in the first direction, and a second GTA is connected to the second guideline in parallel to the first guideline.

3. The GTS as in claim 2, wherein the transmitter selectively transmits the at least one signal over at least one of the first guideline or the second guideline for detection by receiver antennas mounted on the electric vehicle and disposed on opposite sides of the first guideline and the second guideline as the electric vehicle approaches the at least one GTA.

4. The GTS as in claim 3, wherein the first guideline radiates a first signal at a first frequency and the second guideline radiates a second signal at a second frequency for detection of at least one of the first signal or the second signal by the receiver antennas to guide the electric vehicle as the electric vehicle approaches the at least one GTA.

5. The GTS as in claim 3, further comprising a second pair of side-by-side GTAs oriented perpendicular to the first direction, wherein the at least one signal is detected by the receiver antennas to guide at least one VTA of the electric vehicle with respect to the first guideline or the second guideline to at least one GTA of the pair of side-by-side GTAs or the second pair of side-by-side GTAs.

6. The GTS as in claim 4, further comprising a second pair of side-by-side GTAs oriented perpendicular to the first direction, wherein at least one of the first signal or the second signal is detected by the receiver antennas to guide at least one VTA of the electric vehicle with respect to the first guideline or the second guideline to at least one GTA of the pair of side-by-side GTAs or the second pair of side-by-side GTAs.

7. The GTS as in claim 6, wherein the transmitter transmits a GTS beacon from the at least one GTA of the pair of side-by-side GTAs or the second pair of side-by-side GTAs over the first guideline or the second guideline for detection by the receiver antennas to guide at least one VTA of the electric vehicle to the at least one GTA of the pair of side-by-side GTAs or the second pair of side-by-side GTAs depending on whether the first guideline or the second guideline is used to transmit the GTS beacon.

8. The GTS as in claim 2, wherein the first guideline and the second guideline share a common trench.

9. The GTS as in claim 2, wherein the first guideline and the second guideline are discontinuous and are connected to a common guideline by a switch.

10. The GTS as in claim 1, wherein the pair of side-by-side GTAs are oriented in parallel to the first direction, wherein a first GTA is connected to the first guideline, the first guideline extending in the first direction.

11. The GTS as in claim 1, further comprising an inductive communications system that enables the side-by-side GTAs to communicate with corresponding VTAs of the electric vehicle as the electric vehicle approaches the at least one GTA.

12. The GTS as in claim 2, wherein the first guideline is a dipole guideline comprising first and second guideline antenna spans and the second guideline is a dipole guideline comprising third and fourth guideline antenna spans, and wherein the first guideline and the second guideline extend one-quarter wavelength of a first guidance signal transmitted over at least one of the first guideline or the second guideline.

13. The GTS as in claim 12, further comprising a third guideline that is longer than the first guideline and the second guideline and that radiates a second guidance signal that is discernable from the first guidance signal by a separation in frequency, time, or signal coding.

14. The GTS as in claim 13, wherein the third guideline comprises first and second long-line elements that are brought together in a zone at an end of the first guideline and the second guideline in the first direction, and extend from the zone in the first direction in a common trench.

15. The GTS as in claim 14, wherein the first and second long-line elements are discontinuous and are connected to a common antenna wire guideline in the zone by a switch.

16. The GTS as in claim 13, wherein the third guideline provides approach guidance to the electric vehicle over a first distance and the first guideline and second guideline provide approach guidance to the electric vehicle over a second distance shorter than the first distance.

17. The GTS as in claim 16, wherein the third guideline radiates a first beacon signal and at least one of the first guideline or the second guideline radiates a second beacon signal.

18. The GTS as in claim 13, further comprising an end-of-line short range transmitter at an end of the third guideline, the end-of-line short range transmitter receiving data from at least one of the GTAs via the third guideline and broadcasting a location of the at least one GTA and capabilities of the GTS.

19. The GTS as in claim 18, wherein the end-of-line short range transmitter broadcasts information including at least one of power levels offered by the GTS or payment forms available.

20. The GTS as in claim 18, wherein the end-of-line short range transmitter broadcasts information including frequency, modulation, and coding of at least one of the first or second guidance signal for use in matching an active GTA configuration of the GTS with a VTA configuration of the electric vehicle.

21. The GTS as in claim 18, wherein the end-of-line short range transmitter is powered via the third guideline using a DC offset to at least one of a first beacon signal that radiates from the third guideline.

22. The GTS as in claim 5, further comprising third and fourth guidelines extending in a second direction opposite to the first direction from the second pair of side-by-side GTAs, at least one of the third or fourth guidelines radiating a guidance signal that is detected by the receiver antennas to guide the at least one VTA of the electric vehicle with respect to the third guideline or the fourth guideline to at least one GTA of the pair of side-by-side GTAs or the second pair of side-by-side GTAs.

23. The GTS as in claim 1, further comprising a second guideline extending away from at least one of the GTAs a predetermined distance in a second direction opposite to the first direction, wherein the first guideline and the second guideline are adapted to radiate respective guidance signals for guiding an electric vehicle to at least one of the GTAs from the first direction or the second direction.

24. The GTS as in claim 1, further comprising an enclosure for housing the pair of side-by-side GTAs, a separate enclosure for housing the transmitter, and a communications interface connecting the pair of side-by-side GTAs to the transmitter.

25. A method of charging an electric vehicle via at least one vehicle transceiver assembly (VTA) of the electric vehicle using a ground transceiver station (GTS) comprising a pair of side-by-side ground transceiver assemblies (GTAs), each GTA adapted to align with a VTA of the electric vehicle, and a first guideline extending in a first direction from at least one of the GTAs a predetermined distance, comprising:
selecting the GTS for charging the electric vehicle using information provided by the GTS based on an active GTA configuration of the GTS and a VTA configuration of the electric vehicle;
guiding the electric vehicle along the first guideline for alignment of at least one VTA of the electric vehicle with at least one of the GTAs in response to at least one signal radiated by the first guideline for detection by the electric vehicle;
aligning the at least one VTA of the electric vehicle and the at least one of the GTAs; and
initiating wireless charging of the at least one VTA of the electric vehicle upon verification of alignment of the at least one VTA of the electric vehicle and the at least one of the GTAs, wherein each aligned VTA operates independently of each other VTA, and each aligned GTA, paired with a VTA, operates independently from each other GTA.

26. The method of claim 25, wherein selecting the GTS for charging the electric vehicle comprises reserving the GTS, where the GTS has a GTA configuration that is compatible with a VTA configuration of the electric vehicle.

27. The method of claim 26, further comprising updating location or estimated arrival time to a reservation system as the electric vehicle approaches the selected GTS.

28. The method of claim 25, wherein selecting the GTS for charging the electric vehicle comprises querying the at least one VTA for vehicle information including at least one of battery voltage and State of Charge (SoC) or desired SoC.

29. The method of claim 25, wherein selecting the GTS for charging the electric vehicle comprises optimizing at least one of matching a VTA configuration of the at least one VTA of the electric vehicle and a GTA configuration of the at least one of the GTAs, time-required-to-charge, next available compatible GTS, or next available GTS irrespective of a number of GTAs.

30. The method of claim 26, further comprising prioritizing a GTS for selection based on at least one of customer affinity of the electric vehicle, whether the electric vehicle has a reservation, whether the electric vehicle is part of a fleet, or availability of a GTS having a GTA configuration that is compatible with a VTA configuration of the electric vehicle.

31. The method of claim 30, further comprising prioritizing an emergency vehicle over other electric vehicles for charging by a particular GTS.

32. The method of claim 25, further comprising detecting foreign or live objects prior to initiating wireless charging and during wireless charging.

33. The method of claim 25, further comprising maintaining continuous full-duplex inductive communication between each active GTA and each active VTA during wireless charging for monitoring at least one of charging equipment status, detecting changes in position of the electric vehicle during charging, or changes to a state of the electric vehicle.
